(19) United States
(12) Patent Application Publication
(10) Pub. No.: US 2025/0285556 A1
(43) Pub. Date: Sep. 11, 2025

(54) INFORMATION OUTPUT APPARATUS AND METHOD

(71) Applicant: DOT INCORPORATION, SEOUL (KR)

(72) Inventors: Ju Yoon KIM, Gimpo-si (KR); Ji Ho KIM, Gimpo-si (KR); Hyeon Cheol PARK, Gwangmyeong-si (KR)

(21) Appl. No.: 18/599,066

(22) Filed: Mar. 7, 2024

Related U.S. Application Data
(63) Continuation-in-part of application No. 16/494,603, filed on Sep. 16, 2019, now Pat. No. 11,955,027.

(30) Foreign Application Priority Data
Jun. 15, 2017 (KR) 10-2017-0075814
Jul. 5, 2023 (KR) 10-2023-0087321
Dec. 28, 2023 (KR) 10-2023-0195082

(51) Int. Cl. G09B 21/00

(52) U.S. Cl. CPC G09B 21/004; G09B 21/005

(57) ABSTRACT

Provided is an information output apparatus and method. The information output apparatus includes a plurality of expression members configured to protrude or retract by moving in at least one direction and being sensed by a user when protruding or retracting; an activation area calculator configured to calculate a series of braille letters as an activation area on the plurality of expression members; a non-activation area calculator configured to calculate a space between the braille letters as a non-activation area in the activation area; and a plurality of actuation controllers configured to actuate expression members corresponding to the activation area to protrude or retract and configured to actuate expression members corresponding to the non-activation area to retract.

### CROSS-REFERENCE TO RELATED APPLICATION

This application is a Continuation-in-Part Application of U.S. patent application Ser. No. 16/494,603, filed on Sep. 16, 2019, which is a National Stage Entry of International Patent Application No PCT/KR2018/006754, filed on Jun. 15, 2018, which claims priority from and the benefit of Korean Patent Application No. 10-2017-0075814, filed on Jun. 15, 2017. This application also claims priority from and the benefit of Korean Patent Application Nos. 10-2023-0087321, filed on Jul. 5, 2023 and 10-2023-0195082, filed on Dec. 28, 2023, each of which is hereby incorporated by reference for all purposes as if fully set forth herein.

### BACKGROUND

### Field

The present disclosure relates to an information output apparatus and method, and more specifically, to an information output apparatus that is compatible with an external device, and an information output method thereof.

### Discussion of the Background

With the recent remarkable growth in development of smart devices such as smart phones, smart watches, and smart glasses, people are provided with a convenient environment in everyday lives. However, most smart devices are based on a visual graphical user interface (GUI), and it is hard for visually impaired people to use these smart devices since it is hard for them to recognize a mouse pointer or a touch location. Therefore, a user interface for transmitting information using sound or tactile sensation is clearly needed to enable visually impaired people to use smart devices.

Information disclosed in this Background section was already known to the inventors of the present disclosure before achieving the present disclosure or is technical information acquired in the process of achieving the present disclosure. Therefore, it may contain information that does not form the prior art that is already known to the public in this country.

Users can perceive information in various ways. For this purpose, various types of information output apparatuses are used. For example, visual information output apparatuses using printed materials, auditory information output apparatuses using sound, and tactile information output apparatuses using braille are being used.

Meanwhile, as tactile information output apparatuses transmit information by outputting text, the output of images such as graphs and diagrams is limited, which may limit information that visually impaired people can perceive.

In addition, a tactile information output apparatus may obtain information in various fields through communication with an external device (for example, a device that supports screen reading or text reading), but merely receives and outputs such information unilaterally. Furthermore, as the tactile information output apparatus is not allowed to control the external device, it is not easy to effectively utilize the external device.

Therefore, there is a requirement for an information output apparatus that is capable of effectively controlling external devices and outputting information in various fields, obtained from the external devices, not only in forms of texts but also in forms of images such as graphs, diagrams, etc., to facilitate visually impaired people to recognize such information in the various fields in various forms.

### SUMMARY

Embodiments are provided to increase an information recognition rate by allowing a user to easily identify diverse information output through an information output apparatus.

Embodiments are also provided to allow actuators in an information output apparatus to have a uniform life.

Embodiments are to provide an information output apparatus and method that is capable of controlling first and second information output portions to output tactile information by actuating one or more information output units to protrude or retract based on input information (e.g., compatibility information received from an external device), such that an image is displayed on the first information output portion and a text is displayed on the second information output portion, resulting in easily perceiving various types of information through tactile sensation.

Embodiments are to provide an information output apparatus and method that is capable of performing a function corresponding to one or more operation keys selected according to an input for selection with respect to a plurality of operation keys, resulting in changing tactile information based on compatibility information with an external device to facilitate the control for the output of the tactile information or controlling the operation of the external device to effectively utilize the external device.

The problems to be solved by the present disclosure are not limited to those mentioned above, and other problems to be solved and advantages of the present disclosure that are not described herein will be understood from the following description and will be understood more clearly by embodiments of the present disclosure. It will also be understood that the problems to be solved and advantages of the present disclosure can be implemented by the means and combinations thereof mentioned in the appended claims.

According to an aspect of the present disclosure, an information output apparatus includes: a plurality of expression members configured to protrude or retract by moving in at least one direction and being sensed by a user when protruding or retracting; an activation area calculator configured to calculate a series of braille letters as an activation area on the plurality of expression members; a non-activation area calculator configured to calculate a space between the braille letters as a non-activation area in the activation area; and a plurality of actuation controllers configured to actuate expression members corresponding to the activation area among the plurality of expression members to protrude or retract and configured to actuate expression members corresponding to the non-activation area among the plurality of expression members to retract.

The information output apparatus may further include an output object selector configured to select, as an output object, one of externally received information, information stored in the information output apparatus, and/or information generated in the information output apparatus and configured to output the output object to the plurality of expression members.

The information output apparatus may further include an output mode determinator configured to determine one of first through third information output modes as an output mode for the output object selected by the output object selector.

The information output apparatus may further include a processor configured to map the output object corresponding to the output mode determined by the output mode determinator to the plurality of expression members.

The information output apparatus may further include a plurality of actuators respectively connected to the plurality of expression members and configured to respectively actuate the plurality of expression members to protrude or retract under control of the plurality of actuation controllers.

According to another aspect of the present disclosure, an information output method includes: calculating a series of braille letters as an activation area on a plurality of expression members protruding or retracting by moving in at least one direction and being sensed by a user when protruding or retracting; calculating a space between the braille letters as a non-activation area in the activation area; and actuating expression members corresponding to the activation area among the plurality of expression members to protrude or retract and actuating expression members corresponding to the non-activation area among the plurality of expression members to retract.

The information output method may further include selecting, as an output object, one of externally received information, information stored in an information output apparatus, and/or information generated in the information output apparatus and outputting the output object to the plurality of expression members.

The information output method may further include determining one of first through third information output modes as an output mode for the output object selected by an output object selector.

The information output method may further include mapping the output object corresponding to the output mode determined by an output mode determinator to the plurality of expression members.

According to an aspect of the present disclosure, an information output apparatus includes: a first information output portion configured to output first tactile information by actuating one or more first information output units to protrude or retract; a second information output portion disposed at a different position from the first information output portion and configured to output second tactile information by actuating one or more second information output units to protrude or retract; an operating unit including a plurality of operation keys; and a processor configured to generate, in response to a compatible external device being connected, an actuation signal for one or more of the first information output unit and the second information output unit, based on compatibility information received from the external device, transmit the generated actuation signal to one or more of the first information output portion and the second information output portion, and perform a function corresponding to one or more operation keys selected from among the plurality of operation keys.

According to an aspect of the present disclosure, an information output method that is performed by an information output apparatus includes: generating an actuation signal for one or more of a first information output unit and a second information output unit based on compatibility information received from a compatible external device, in response to the compatible external device being connected; transmitting the actuation signal to one or more of a first information output portion and a second information output portion; and receiving an input selecting one or more operation keys from among a plurality of operation keys to perform a function corresponding to the selected one or more operation keys, wherein the first information output portion outputs first tactile information by actuating one or more first information output units to protrude or retract, and the second information output portion is disposed at a different position from the first information output portion and outputs second tactile information by actuating one or more second information output units to protrude or retract.

Other aspects, features, and advantages than those described above will be clear from the accompanying drawings, the claims, and the description of embodiments below.

According to embodiments, an information recognition rate, at which a user recognizes image information output in an information output apparatus, may be increased.

In addition, an information recognition rate, at which a user recognizes braille information output in an information output apparatus, may be increased.

An information recognition rate, at which a user recognizes each of image information and braille information simultaneously output in an information output apparatus, may be increased.

Furthermore, actuators respectively corresponding to an activation area and a non-activation area may have a uniform life by shifting the activation area, which includes image information and/or braille information output in an information output apparatus, and the non-activation area, which distinguishes the image information and/or the braille information, in a certain direction.

According to an embodiment, an information output apparatus and method may be provided that is capable of controlling first and second information output portions to output tactile information by actuating one or more information output units to protrude or retract based on input information (e.g., compatibility information received from an external device), such that an image is displayed on the first information output portion and a text is displayed on the second information output portion, resulting in easily perceiving various types of information through tactile sensation.

Furthermore, according to the present disclosure, an information output apparatus and method may be provided that is capable of performing a function corresponding to one or more selected operation keys according to an input for selection with respect to a plurality of operation keys, resulting in changing tactile information based on compatibility information with an external device to facilitate the control for the output of the tactile information or controlling the operation of the external device to effectively utilize the external device.

Advantageous effects of the present disclosure are not limited to those mentioned above, and other advantageous effects that have not been mentioned will be clearly understood by one of skill in the art from the description below.

### BRIEF DESCRIPTION OF THE DRAWINGS

FIG. 1 is a schematic diagram of an information output apparatus according to an embodiment.

FIG. 2 is a schematic diagram of the detailed configuration of a first information processing unit in the information output apparatus of FIG. 1.

FIG. 3 is a schematic diagram of the detailed configuration of a processor and a calculator in the first information processing unit of FIG. 2, according to an embodiment.

FIG. 4 is a schematic diagram of the detailed configuration of the processor and the calculator in the first information processing unit of FIG. 2, according to another embodiment.

FIG. 5 is a schematic diagram of the detailed configuration of the processor and the calculator in the first information processing unit of FIG. 2, according to another embodiment.

FIG. 6 is a schematic diagram of the detailed configuration of an information output unit in the information output apparatus of FIG. 1.

FIG. 7 is a schematic diagram of the detailed configuration of a second information processing unit in the information output apparatus of FIG. 1.

FIG. 8 is a diagram of the front of an information output apparatus according to an embodiment.

FIG. 9 is a diagram of a side of an information output apparatus according to an embodiment.

FIGS. 10A and 10B are exemplary diagrams relating to information output in the information output apparatus 1000 of FIG. 8, according to an embodiment.

FIGS. 11 through 13 are exemplary diagrams relating to information output in the information output apparatus 1000 of FIG. 8, according to another embodiment.

FIGS. 14A and 14B are exemplary diagrams relating to a shift result of an information output apparatus, according to an embodiment.

FIGS. 15 through 17 are flowcharts of an information output method according to an embodiment.

FIG. 18 is a flowchart of a shift method of an information output apparatus, according to an embodiment.

FIG. 19 is a diagram of an example of an information output system including an information output apparatus, according to an embodiment.

FIG. 20 is a diagram of another example of the information output system including the information output apparatus, according to an embodiment.

FIG. 21 is a diagram of an example of the configuration of an information output apparatus, according to an embodiment.

FIG. 22 is a schematic diagram of appearance of the information output apparatus, according to an embodiment.

FIG. 23 is a diagram of information output cells included in a first information output portion and a second information output portion within the information output apparatus, according to an embodiment.

FIGS. 24 through 26 are diagrams of an example of controlling an external device in an information output apparatus, according to an embodiment.

FIGS. 27 and 28 are diagrams of another example of controlling an external device in an information output apparatus according to an embodiment.

FIGS. 29 and 30 are diagrams of another example of controlling an external device in an information output apparatus according to an embodiment.

FIG. 31 is a diagram of another example of controlling an external device in an information output apparatus according to an embodiment.

FIG. 32 is a diagram of an example of an interactive information processing device, as an external device, connected to an information output apparatus, according to an embodiment.

FIG. 33 is a diagram of an example of the performance of functions, in the form of table, according to selection of operation keys in an information output apparatus, according to an embodiment.

FIG. 34 is a flowchart of an information output method according to an embodiment.

### DETAILED DESCRIPTION

Advantages, features, and methods for achieving the effects and features will become more apparent by explaining the embodiments in detail with reference to the accompanying drawings. However, the present disclosure is not limited to these embodiments but may be implemented in various modes, and it is to be appreciated that all changes, equivalents, and substitutes that do not depart from the spirit and technical scope of the inventive concept are encompassed in embodiments. Rather, these embodiments are provided so that this disclosure will be thorough and complete, and will fully convey the scope of the embodiments to one of ordinary skill in the art. In the description of embodiments certain detailed explanations of the related art are omitted when it is deemed that they may unnecessarily obscure the essence of the present disclosure.

The terms used in the present application are merely used to describe example embodiments and are not intended to limit embodiments. An expression used in the singular encompasses the expression of the plural, unless it has a clearly different meaning in the context. In the present application, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While such terms “first,” “second,” etc., may be used to describe various components, such components must not be limited to the above terms. The above terms are used only to distinguish one component from another.

The embodiments of the present disclosure will now be described in detail with reference to the accompanying drawings, in which like reference numerals denote like elements, and thus their description will be omitted.

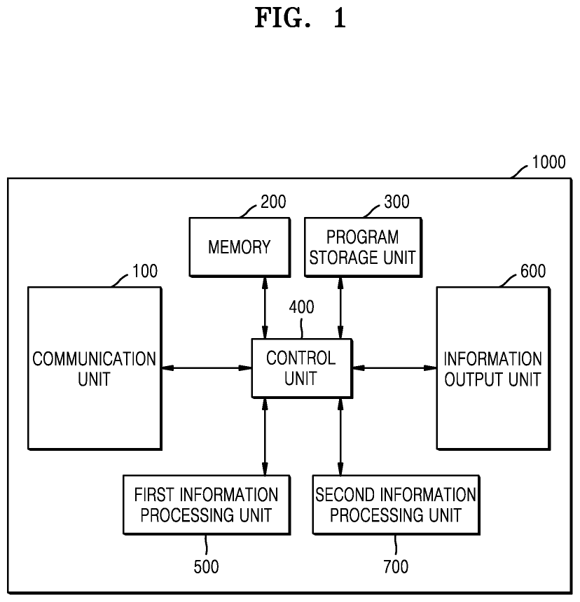

FIG. 1 is a schematic diagram of an information output apparatus according to an embodiment. Referring to FIG. 1, an information output apparatus 1000 may include a communication unit 100, a memory 200, a program storage unit 300, a control unit 400, a first information processing unit 500, an information output unit 600, and a second information processing unit 700.

The communication unit 100 may transmit a signal between an external device (e.g., an information providing system, a server, or another information output device) and the information output apparatus 1000 in association with a communication network and may provide a communication interface needed to provide a transmission/reception signal in a form of packet data. Furthermore, the communication unit 100 may receive a certain information request signal from the information output apparatus 1000 and transmit information processed by the information output apparatus 1000 to outside the information output apparatus 1000. Here, the communication network is a medium connecting an external device to the information output apparatus 1000 and may include a channel providing an access route such that the information output apparatus 1000 may transmit and receive data after accessing the external device. Examples of the communication network may include wired networks such as local area networks (LANs), wide area networks (WANs), metropolitan area networks (MANs), and integrated service digital networks (ISDNs) and wireless networks such as wireless LANs, code division multiple access (CDMA), Bluetooth, and satellite communications, but the scope of the present disclosure is not limited thereto. The communication unit 100 may be a device that includes hardware or software needed to transmit and receive signals, such as control signals or data signals, to and from another network device via a wired or wireless connection.

The memory 200 may temporarily or permanently store information processed by the control unit 400 and/or information externally received through the communication unit 100. Here, the memory 200 may include a magnetic storage medium or a flash storage medium, but the scope of the present disclosure is not limited thereto.

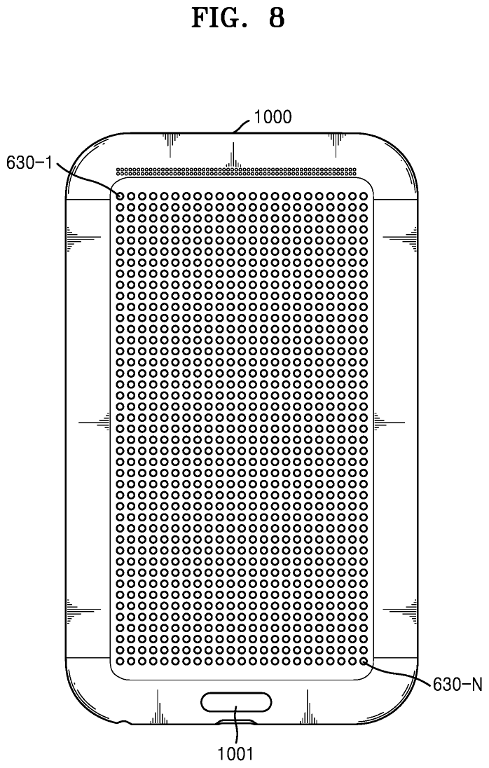

The program storage unit 300 may be equipped with control software that performs a task of selecting an output object to be output in the information output apparatus 1000, a task of determining an output mode, a task of processing information according to the determined output mode, a task of calculating an output position of the processed information in the information output apparatus 1000, a task of controlling actuation of an expression member (630 in FIGS. 8 through 13) according to the output position, a task of calculating an operating time of the information output apparatus 1000, a task of calculating an actuation time and/or an operation count of the expression member, a task of shifting an actuation position of the expression member in a certain direction and so on.

The control unit 400 is a kind of a central processing unit and may control the entire procedure for processing information and outputting an information processing result in the information output apparatus 1000 in conjunction with the program storage unit 300 when the information output apparatus 1000 accesses an external device and receives an information request signal or internally generates information.

In this embodiment, the control unit 400 may include any type of device like a processor that is capable of processing random information. Here, a “processor” may, for example, refer to a data processing device that is built in hardware and includes a circuit physically structured to perform a function represented by code or instructions contained in a program. Examples of a data processing device built in hardware may include a microprocessor, a central processing unit (CPU), a processor core, a multiprocessor, an application-specific integrated circuit (ASIC), and a field programmable gate array (FPGA), but the scope of the present disclosure is not limited thereto.

The first information processing unit 500 may process information externally received through the communication unit 100, information stored in the memory 200, and/or internally generated information (e.g., text message information produced in the information output apparatus 1000) to be output in the information output apparatus 1000. In this embodiment, “information” may include image information and/or braille information, and the image information may include a still cut such as a photograph, a cartoon, or a picture, a moving image, and/or a series of texts.

The first information processing unit 500 may select an output object from image information and/or braille information, determine an information output mode for the selected output object, perform information processing on the output object according to the determined information output mode, and calculate an activation area and a non-activation area. In this embodiment, calculation of an activation area or a non-activation area may refer to calculation of an actuated (protrusion or retraction) position of an expression member in the information output apparatus 1000.

The information output unit 600 may actuate each of expression members respectively corresponding to a position of the activation area and a position of the non-activation area, which are calculated by the first information processing unit 500, to protrude and/or retract such that a user may perceive the expression members using tactile sensation.

The second information processing unit 700 may shift the activation area and the non-activation area in a certain direction after a certain time period elapses. Here, the certain time period may include at least one selected from an absolute time, an operating time of the information output apparatus 1000, and a protruding or retracting actuation time of an expression member positioned in an activation area. In addition, the certain direction may include a horizontal direction shifting by at least one column or a vertical direction shifting by at least one row. As described above, the certain direction may further include the number of columns and/or the number of rows, that is, the amount of shift, together with a direction.

In an optional embodiment, the second information processing unit 700 may shift an activation area and a non-activation area in the certain direction when a certain frequency is exceeded. Here, the certain frequency may include the frequency of protrusions and retractions of an expression member in the activation area.

In an optional embodiment, the second information processing unit 700 may shift an activation area and a non-activation area in the certain direction when a shift request signal is received from a user. Here, the user may select a shift direction, and when the user does not select the shift direction, a programmed shift direction may be selected.

As described above, when the second information processing unit 700 shifts an activation area and a non-activation area in a certain direction, actuators actuating an expression member may have a uniform life.

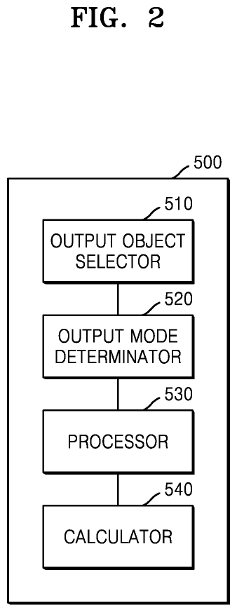

FIG. 2 is a schematic diagram of the detailed configuration of the first information processing unit 500 in the information output apparatus 1000 of FIG. 1. Referring to FIG. 2, the first information processing unit 500 may include an output object selector 510, an output mode determinator 520, and a calculator 540.

The output object selector 510 may select an output object to be output in the information output apparatus 1000 from information externally received through the communication unit 100, information stored in the memory 200, and/or internally generated information. To select an output object, the output object selector 510 may ask a user which information is determined as the output object and select the output object, i.e., image information or braille information or mixed information including image information and braille information, in response to the user's choice.

In an embodiment, the output object selector 510 may select an output object in time order. For example, when there are braille information externally received through the communication unit 100 and image information stored in the memory 200 and the braille information externally received through the communication unit 100 is earliest, the output object selector 510 may select the braille information externally received through the communication unit 100 as the output object. In another embodiment, the output object selector 510 may select an output object according to priority predetermined by a user. For example, when braille information is set to have priority over image information and mixed information, the output object selector 510 may select, as the output object, braille information among information externally received through the communication unit 100, information stored in the memory 200, and/or internally generated information.

The output mode determinator 520 may determine an information output mode for the output object selected by the output object selector 510. The output mode determinator 520 may classify the information output mode into three modes including an image information output mode as a first information output mode, a braille information output mode as a second information output mode, and a mixed information output mode (i.e., an image and braille information output mode) as a third information output mode. The information output mode is classified as described above since an output method is different according to the type of information. The image information output mode as the first information output mode may include a mode in which only image information is output in the information output apparatus 1000. The braille information output mode as the second information output mode may include a mode in which only braille information is output in the information output apparatus 1000. The mixed information output mode as the third information output mode may include a mode in which a display area of the information output apparatus 1000 is divided into at least two display areas and different types of information are output to the respective display areas.

The processor 530 may perform information processing for information output according to the determined output mode. In the image information output mode as the first information output mode, the processor 530 may divide image information to be output into a foreground area and a background area and map the foreground area and the background area to a plurality of expression members in the information output apparatus 1000. In the braille information output mode as the second information output mode, the processor 530 may map braille information to be output to the expression members in the information output apparatus 1000. In this embodiment, text information may be converted into braille information, and the braille information may be mapped to the expression members in the information output apparatus 1000. In this case, the processor 530 may further include a function of converting text information into braille information. In the mixed information output mode as the third information output mode, the processor 530 may divide the display area of the information output apparatus 1000 into at least two sections and map image information and braille information, each to be output, to expression members in the display areas.

The calculator 540 may calculate an activation area and a non-activation area with respect to output members in the information output apparatus 1000 in response to an information processing result of the processor 530. In this embodiment, the activation area may include an area in which an expression member is dynamically actuated to protrude or retract, and the non-activation area may include an area in which an expression member is not dynamically actuated to protrude and/or retract but remains retracted until an output mode ends. Here, remaining retracted may vary with an output mode. At least one expression member may be maintained retracted in one output mode and may be actuated to protrude or retract in another mode. Accordingly, in this embodiment, the calculation of an activation area may include calculating a protrusion actuated position or a retraction actuated position of an expression member, and the calculation of a non-activation area may include calculating a position at which retraction is maintained for an expression member.

In the image information output mode as the first information output mode, the calculator 540 may calculate a first activation area and a second activation area from a result of mapping image information to be output to a plurality of expression members in the information output apparatus 1000. In the image information output mode as the first information output mode, the calculation of the first activation area may include calculating a protrusion actuated position of an expression member for a foreground area of the image information and the calculation of the second activation area may include calculating a retraction actuated position of an expression member for a background area of the image information, and vice versa. Accordingly, it may be seen that there is no non-activation area in the image information output mode as the first information output mode.

In the braille information output mode as the second information output mode, the calculator 540 may calculate an activation area and a non-activation area from a result of mapping braille information to be output to a plurality of expression members in the information output apparatus 1000. In the braille information output mode as the second information output mode, the calculation of the activation area may include calculating a protrusion and/or retraction actuated position of an expression member for the braille information and the calculation of the non-activation area may include calculating a retraction maintained position of an expression member, for which retraction is maintained, in at least one selected from the space between braille columns, the space between braille rows, and the space between braille paragraphs in the activation area.

In the mixed information output mode as the third information output mode, the calculator 540 may calculate a first activation area and a second activation area with respect to a result of mapping image information to be output to a plurality of expression members in the information output apparatus 1000 and calculate an activation area and a non-activation area with respect to a result of mapping braille information to be output to a plurality of expression members in the information output apparatus 1000.

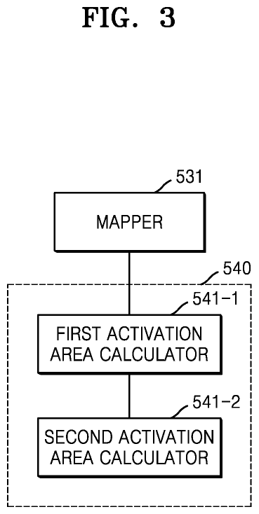

FIG. 3 is a schematic diagram of the detailed configuration of the processor 530 and the calculator 540 in the first information processing unit 500 of FIG. 2, according to an embodiment. Referring to FIG. 3, the processor 530 may include a mapper 531, and the calculator 540 may include a first activation area calculator 541-1 and a second activation area calculator 541-2. Accordingly, it may be said that FIG. 3 is a diagram for explaining information processing and calculation in the image information output mode as the first information output mode.

The mapper 531 may map image information to be output to a plurality of expression members in the information output apparatus 1000. The mapper 531 may perform first mapping on a foreground area of the image information and second mapping on a background area of the image information. In this embodiment, the first mapping may include mapping the foreground area to a plurality of expression members in the information output apparatus 1000 and the second mapping may include mapping the background area to a plurality of expression members in the information output apparatus 1000.

The first activation area calculator 541-1 may calculate a protrusion actuated position of each of expression members in the foreground area according to a first mapping result. Thereafter, when first mapped expression members for the foreground area are actuated by the information output unit 600 to protrude, a user may recognize the foreground area of the image information by sensing the first mapped expression members.

The second activation area calculator 541-2 may calculate a retraction actuated position of each of expression members in the background area according to a second mapping result. Thereafter, when second mapped expression members for the background area are actuated by the information output unit 600 to retract, a user may recognize the background area of the image information by sensing the second mapped expression members.

The size of the image information output in the information output apparatus 1000 may be controlled by a user's touch gesture or operation of a button (1001 in FIG. 8) in a current state. When an image size control signal is received, the mapper 531 may newly perform mapping on the foreground area and the background area, and protrusion and retraction actuated positions of expression members may be newly calculated. In addition, when the information output apparatus 1000 rotates (to landscape or portrait) according to a gyro sensor (not shown) sensing a rotation state of the information output apparatus 1000, the mapper 531 may newly perform mapping on the foreground area and the background area in response to a rotation result, and protrusion and retraction actuated positions of expression members may be newly calculated.

The case where image information to be output is not pure image information but text information will be described in an embodiment. For example, the case where the text “Korea automobile” is output in the information output apparatus 1000 may be included. In this case, the mapper 531 may map text information to be output to a plurality of expression members in the information output apparatus 1000. The mapper 531 may perform first mapping on text itself of the text information and second mapping on the other portion excluding the text. In this embodiment, the first mapping may include mapping the text itself to a plurality of expression members in the information output apparatus 1000 and the second mapping may include mapping the other portion excluding the text to a plurality of expression members in the information output apparatus 1000. In other words, the second mapping may be performed on all N×N expression members except first mapped expression members.

The first activation area calculator 541-1 may calculate a protrusion actuated position of each of expression members in the text itself according to a first mapping result. Thereafter, when first mapped expression members for the text itself are actuated by the information output unit 600 to protrude, a user may recognize the text by sensing the first mapped expression members.

The second activation area calculator 541-2 may calculate a retraction actuated position of each of expression members in the other portion excluding the text according to a second mapping result. Thereafter, when second mapped expression members for the other portion excluding the text are actuated by the information output unit 600 to retract, a user senses the second mapped expression members, and accordingly, the recognition rate of the text may be increased.

The size of the text information output in the information output apparatus 1000 may be controlled by a user's touch gesture or operation of a button (1001 in FIG. 8) in a current state. When a text size control signal is received, the mapper 531 may newly perform mapping on the text itself and the other portion excluding the text, and protrusion and retraction actuated positions of expression members may be newly calculated. In addition, when the information output apparatus 1000 rotates (to landscape or portrait) according to a gyro sensor (not shown) sensing a rotation state of the information output apparatus 1000, the mapper 531 may newly perform mapping on the text itself and the other portion excluding the text in response to a rotation result, and protrusion and retraction actuated positions of expression members may be newly calculated.

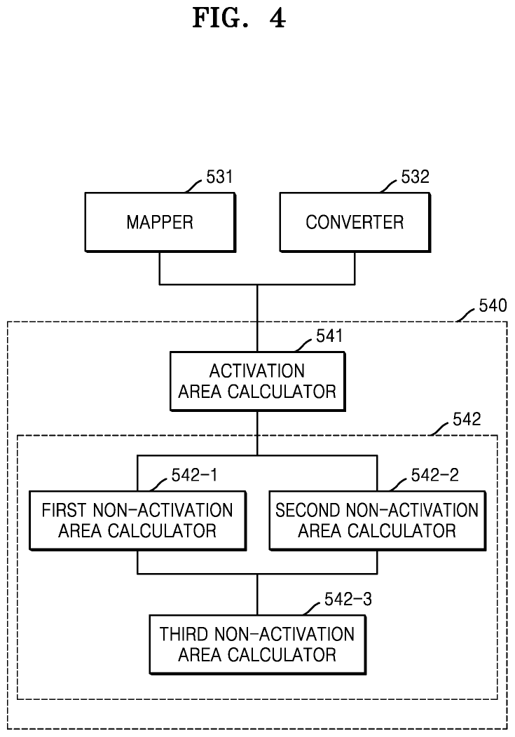

FIG. 4 is a schematic diagram of the detailed configuration of the processor 530 and the calculator 540 in the first information processing unit 500 of FIG. 2, according to another embodiment. Referring to FIG. 4, the processor 530 may include the mapper 531 and a converter 532 and the calculator 540 may include an activation area calculator 541 and a non-activation area calculator 542. Accordingly, it may be said that FIG. 4 is a diagram for explaining information processing and calculation in the braille information output mode as the second information output mode.

The mapper 531 may map braille information to a plurality of expression members in the information output apparatus 1000. The braille information may be output in units of braille cells including six dots in three rows and two columns. In this embodiment, a braille cells may include six expression members and a single braille letter may be output using six expression members. In this embodiment, a single braille cell includes six expression members, but the present disclosure is not limited thereto. A single braille cell may include two to eight expression members and, in some cases, may include more expression members. The mapper 531 may map braille information including at least one selected from a word, a sentence component, a sentence, and a paragraph.

In an embodiment, the converter 532 may convert externally received text information and/or internally generated text information into braille information. The converter 532 may store a braille table and braille letters including Hangeul consonants (custom-character, . . . , custom-character), Hangeul vowels (custom-character, . . . , custom-character), tense consonants (custom-character), abbreviations (custom-character, custom-character, . . . , custom-character, custom-character, custom-character) digits (1, 2, 3, . . . , 0), signs (?, !, +, . . . ), or English alphabets (A, B, C, . . . , Z). Accordingly, when text information is received, the converter 532 may convert the text information into braille information based on the braille table and transmit the braille information to the mapper 531 such that the braille information may be mapped to a plurality of expression members in the information output apparatus 1000.

The activation area calculator 541 may calculate protrusion actuated positions and retraction actuated positions of expression members corresponding to the braille information according to a mapping result. Thereafter, when the expression members for a braille letter are actuated by the information output unit 600 to protrude and/or retract, a user may recognize the braille letter by sensing the positions and number of expression members in a braille cell.

The non-activation area calculator 542 may calculate a retraction maintained position of an expression member for making braille distinguished in an activation area. In this embodiment, the non-activation area calculator 542 may include first through third non-activation area calculators 542-1 through 542-3.

The first non-activation area calculator 542-1 may calculate, as a first non-activation area, an expression member array, for example, of three rows and one column, between braille columns to distinguish one braille column from another. Thereafter, when the first non-activation area, i.e., the expression member array of three rows and one column, is maintained retracted by the information output unit 600, a user may sense the positions and number of retraction maintained expression members and recognize an area distinguishing one braille column from another.

The second non-activation area calculator 542-2 may calculate, as a second non-activation area, an expression member array, for example, of one row and one column, between braille rows to distinguish one braille row from another. Thereafter, when the second non-activation area, i.e., the expression member array of one row and one column, between braille rows is maintained retracted by the information output unit 600, a user may sense the positions and number of retraction maintained expression members and recognize an area distinguishing one braille row from another.

The third non-activation area calculator 542-3 may calculate, as a third non-activation area, an expression member array, for example, of two rows and two columns, between braille paragraphs to distinguish one braille paragraph from another. Thereafter, when the third non-activation area, i.e., the expression member array of two rows and two columns, between braille paragraphs is maintained retracted by the information output unit 600, a user may sense the positions and number of retraction maintained expression members and recognize an area distinguishing one braille paragraph from another.

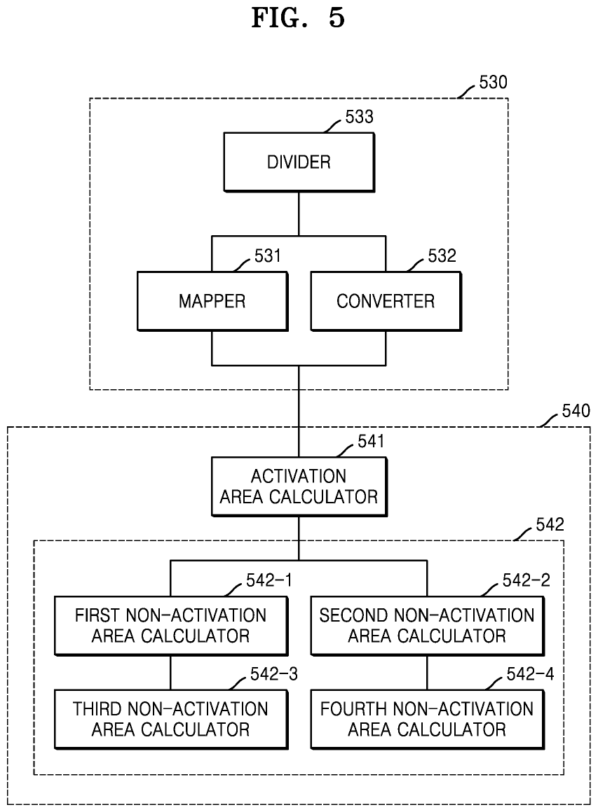

FIG. 5 is a schematic diagram of the detailed configuration of the processor 530 and the calculator 540 in the first information processing unit 500 of FIG. 2, according to another embodiment. Referring to FIG. 5, the processor 530 may include the mapper 531, the converter 532, and a divider 533 and the calculator 540 may include the activation area calculator 541 and the non-activation area calculator 542. Accordingly, it may be said that FIG. 5 is a diagram for explaining information processing and calculation in the mixed information output mode (i.e., an image and braille information output mode) as the third information output mode.

For the mixed information output mode as the third information output mode, the divider 533 may divide the information output apparatus 1000 into a first display area and a second display area such that image information may be output to one of the first and second display area and braille information may be output to the other section. For example, it is assumed that image information is output to the first display area and braille information is output to the second display area.

In an optional embodiment, the divider 533 may fix the first display area and move the second display area. Here, the fixing of the first display area may refer to maintaining output of image information in the first display area and the moving of the second display area may refer to changing output of braille information in the second display area. For example, when braille information including first through third paragraphs needs to be output to the second display area in a state where image information has been output to the first display area, all of the first through third paragraphs could not be simultaneously output to the second display area. In this case, in a state where the first display area is fixed, braille information corresponding to the first paragraph may be first output to the second display area and then braille information corresponding to the second paragraph and braille information corresponding to the third paragraph may be sequentially output at a certain time interval (e.g., of 1 second) or when a user's touch is sensed in an end portion of the second display area.

The mapper 531 may map image information to be output to a plurality of expression members in the first display area and braille information to be output to a plurality of expression members in the second display area. The converter 532 may convert text information into braille information and transmit the braille information to the mapper 531. The detailed descriptions of the mapper 531 and the converter 532 are the same as those given in FIGS. 3 and 5 and thus will be omitted.

The activation area calculator 541 may calculate a protrusion actuated position of each of expression members in a foreground area and a retraction actuated position of each of expression members in a background area according to a result of mapping image information to be output to the first display area and may calculate protrusion actuated positions and/or retraction actuated positions of expression members according to a result of mapping braille information to be output to the second display area.

The non-activation area calculator 542 may calculate a retraction maintained position of an expression member for making braille distinguished in an activation area of the second display area and may calculate a retraction maintained position of an expression member for a fourth non-activation area, i.e., a separating non-activation area, which separates the first display area from the second display area. In this embodiment, the non-activation area calculator 542 may include first through fourth non-activation area calculators 542-1 through 542-4. The operations of the first through third non-activation area calculators 542-1 through 542-3 are the same as those described in FIG. 4, excepting that braille is output to the second display area, and thus descriptions thereof will be omitted.

To separate image information from braille information, the fourth non-activation area calculator 542-1 may calculate, as a fourth non-activation area, an expression member array arranged in, for example, three rows and three columns, between the first display area and the second display area. Thereafter, when the fourth non-activation area, i.e., the expression member array of three rows and three columns, between the first display area and the second display area is maintained retracted by the information output unit 600, a user may sense the positions and number of retraction maintained expression members and recognize an area separating the first display area from the second display area.

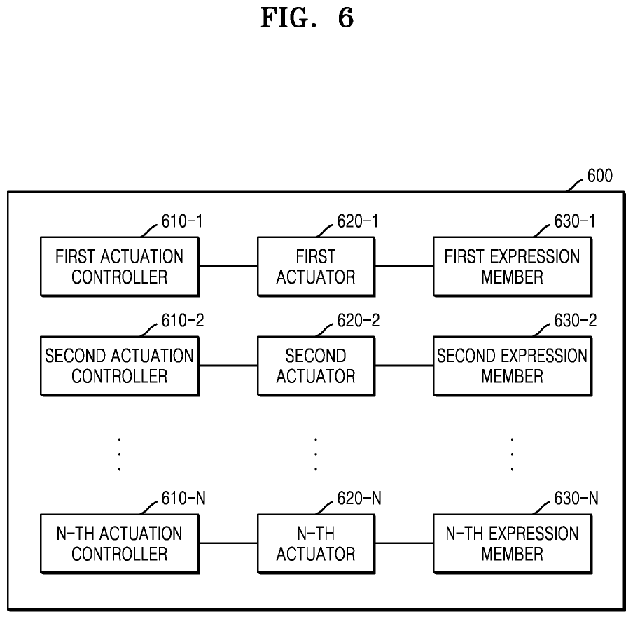

FIG. 6 is a schematic diagram of the detailed configuration of the information output unit 600 in the information output apparatus 1000 of FIG. 1. Referring to FIG. 6, the information output unit 600 may include first through N-th actuation controllers 610-1 through 610-N, first through N-th actuators 620-1 through 620-N, and first through N-th expression members 630-1 through 630-N respectively connected to the first through N-th actuators 620-1 through 620-N performing a linear motion (i.e., protrusion or retraction) under the control of the first through N-th actuation controllers 610-1 through 610-N, respectively.

The first through N-th actuation controllers 610-1 through 610-N may respectively control the first through N-th actuators 620-1 through 620-N according to an activation area calculation result and a non-activation area calculation result, which are output from the first information processing unit 500, such that at least one selected from the first through N-th expression members 630-1 through 630-N is actuated to protrude and/or retract. The first through N-th actuation controllers 610-1 through 610-N may control a duration of a protrusion actuated state and/or a retraction actuated state with respect to expression members, respectively.

In this embodiment, protrusion actuating may include controlling a corresponding actuator such that at least one selected from the first through N-th expression members 630-1 through 630-N is raised at least a certain height (e.g., 0.5 cm) from a bottom surface of a display area of the information output apparatus 1000. In this embodiment, retraction actuating may include controlling a corresponding actuator such that at least one selected from the first through N-th expression members 630-1 through 630-N does not rise from or is positioned at the bottom surface of the display area of the information output apparatus 1000.

In the image information output mode, the first through N-th actuation controllers 610-1 through 610-N may control a corresponding actuator such that at least one expression member, which is mapped to a first activation area calculation result output from the first information processing unit 500 among the first through N-th expression members 630-1 through 630-N, is actuated to protrude and may control a corresponding actuator such that at least one expression member, which is mapped to a second activation area calculation result output from the first information processing unit 500 among the first through N-th expression members 630-1 through 630-N, is actuated to retract.

In the braille information output mode, the first through N-th actuation controllers 610-1 through 610-N may control a corresponding actuator such that at least one expression member, which is mapped to an activation area calculation result output from the first information processing unit 500 among the first through N-th expression members 630-1 through 630-N, is actuated to protrude and/or retract and may control a corresponding actuator such that at least one expression member, which is mapped to a non-activation area calculation result output from the first information processing unit 500 among the first through N-th expression members 630-1 through 630-N, is maintained retracted.

In the mixed information output mode, the first through N-th actuation controllers 610-1 through 610-N may divide the first through N-th expression members 630-1 through 630-N into the first display area and the second display area, may control a corresponding actuator such that an expression member in the first display area is actuated to protrude and/or retract in correspondence to the image information output mode, and may control a corresponding actuator such that an expression member in the second display area is actuated to protrude and/or retract or maintained retracted in correspondence to the braille information output mode. In this embodiment, the first through N-th actuation controllers 610-1 through 610-N may operate such that an expression member array of three rows and three columns is maintained retracted in the fourth non-activation area.

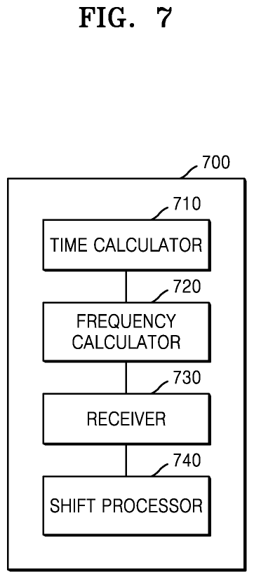

FIG. 7 is a schematic diagram of the detailed configuration of the second information processing unit 700 in the information output apparatus 1000 of FIG. 1. Referring to FIG. 7, the second information processing unit 700 may include a time calculator 710, a frequency calculator 720, a receiver 730, and a shift processor 740.

It may be seen from the embodiments described above that each of expression members 630 in the activation area and the non-activation area is connected or mapped to an actuator 620 and protrudes or retracts due to the linear motion of the actuator 620 controlled by an actuation controller 610, and accordingly, protrusion or retraction of each expression member 630 coincides with protrusion or retraction of the actuator 620. In addition, the actuator 620 mechanically operates the expression member 630 under the control of the actuation controller 610 and thus includes an operating life such that the actuator 620 stops operating after a certain time elapses.

An actuator 620 mapped to the activation area may protrude or retract and an actuator 620 mapped to the non-activation area may maintain retraction. The non-activation area, in which retraction is maintained, may include the first non-activation area (e.g., an array of actuators 620 arranged in three rows and one column between braille columns) in a fixed location, the second non-activation area (e.g., an array of actuators 620 arranged in one row and one column between braille rows) in a fixed location, the third non-activation area (e.g., an array of actuators 620 arranged in two rows and two columns between braille paragraphs) in a fixed location, and the fourth non-activation area (e.g., an array of actuators 620 arranged in three rows and three columns between the first display area and the second display area) in a fixed location. Therefore, the operating time and/or number of the actuator 620 in the activation area may be different from the operating time and/or number of the actuator 620 in the non-activation area, and accordingly, the life of the actuator 620 in the activation area is different from the life of the actuator 620 in the non-activation area. In detail, the life of the actuator 620 in the activation area is shorter. A difference in the life of the actuator 620 may affect the smooth operation of the information output apparatus 1000. Furthermore, the life of the information output apparatus 1000 may be shorter than a predetermined time.

When the second information processing unit 700 shifts the activation area and the non-activation area in a certain direction in response to an elapse of a certain time, an excess of a certain frequency, or a user's shift request signal, all actuators 620 may have a uniform life.

The time calculator 710 may calculate a certain time in which the activation area and the non-activation area may be shifted. Here, the calculation of the certain time may include counting and accumulating the certain time. In addition, the certain time may include an absolute time including either a first shift start time (e.g., a week or a month from a setting start time), which is set by a user, or a second shift start time (e.g., 200 hours from the initial operation of the information output apparatus 1000), which is programmed and stored in the program storage unit 300 during the manufacture of the information output apparatus 1000. In addition, the certain time may include a third shift start time (e.g., 150 hours from the initial operation of the information output apparatus 1000) indicating an operating time in which the information output apparatus 1000 substantially outputs information. In this embodiment, the second shift start time may be different from the third shift start time. The second shift start time may include a time continuously counted since the initial operation of the information output apparatus 1000, in both the case where the information output apparatus 1000 outputs information and the case where the information output apparatus 1000 does not output information. The third shift start time may include a time counted only when the information output apparatus 1000 outputs information. In addition, the certain time may include a fourth shift start time (e.g., 100 hours of protrusion and 100 hours of retraction) indicating a protrusion actuating time and a retraction actuating time of each actuator 620 in the activation area. The shift processor 740 may shift the activation area and the non-activation area in a certain direction when one of the first through fourth shift start times is reached or may set a priority order for the first through fourth shift start times and shift the activation area and the non-activation area in a certain direction when a shift start time having priority is reached.

The frequency calculator 720 may calculate a certain frequency at which the activation area and the non-activation area may be shifted in a certain direction. Here, the calculation of the certain frequency may include counting and accumulating the certain frequency, i.e., a certain number. The certain frequency may include a protrusion actuating frequency and a retraction actuating frequency (e.g., 1000 protrusions and retractions) of each actuator 620 in the activation area since the initial operation of the information output apparatus 1000.

The receiver 730 may receive a shift request signal from a user such that the activation area and the non-activation area may be shifted in a certain direction. In this embodiment, the shift request signal received from a user may be given a top priority over the certain time and the certain frequency. The receiver 730 may receive a shift direction setting signal from a user. When the shift direction setting signal is not received from the user, a programmed shift direction may be set.

The shift processor 740 may substantially shift the activation area and the non-activation area in a certain direction in response to an elapse of the certain time, an excess of the certain frequency, and the user's shift request signal. Here, the certain direction may include a programmed horizontal direction shifting by at least one column or a programmed vertical direction shifting by at least one row. As described above, the certain direction may further include the number of columns and/or the number of rows, that is, the amount of shift, together with a direction. The certain direction may include a direction in which a previous activation area is converted into a non-activation area after the shift. In an optional embodiment, the shift processor 740 may calculate an average of protrusion and retraction actuating times and/or an average of protrusion and retraction actuating frequencies with respect to each actuator 620 in the activation area and may shift the activation area and the non-activation area in a certain direction such that an actuator 620 having a highest actuating time and/or a highest actuating frequency is located in the non-activation area. In an optional embodiment, when there is at least one dummy area (e.g., one or two rightmost/leftmost lines or one or two topmost/bottom most lines in the information output apparatus 1000), in which a braille cell having three rows and two columns cannot be formed, in the activation area after the activation area and the non-activation area are shifted, the shift processor 740 may convert the dummy area into the non-activation area.

FIG. 8 is a diagram of the front of the information output apparatus 1000 according to an embodiment. Referring to FIG. 8, the front of the information output apparatus 1000 may include N expression members 630-1 through 630-N to output image information, braille information, or mixed information, and the N expression members 630-1 through 630-N may be actuated to protrude or retract by the linear motion of the first through N-th actuators 620-1 through 620-N, respectively, under the control of the first through N-th actuation controllers 610-1 through 610-N, respectively. In addition, the information output apparatus 1000 of FIG. 8 may include at least one button 1001 and may perform an additional function (e.g., power-on, returning to a previous stage, selecting, moving a screen, or screen zooming) corresponding to an input of the button 1001.

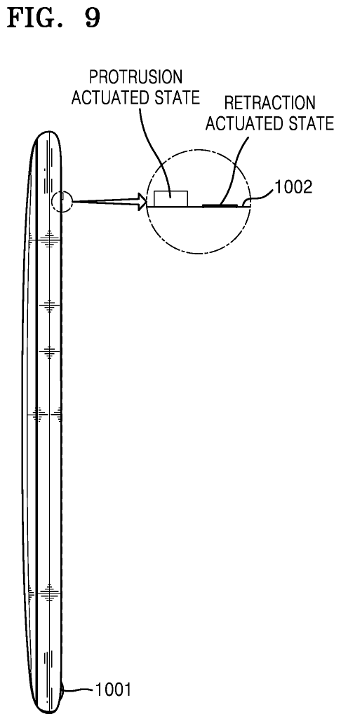

FIG. 9 is a diagram of a side of an information output apparatus 1000 according to an embodiment. Referring to FIG. 9, a protrusion actuated state of an expression member 630 and a retraction actuated state of an expression member 630 may be recognized when viewed from the side of the information output apparatus 1000. The protrusion actuated state of the expression member 630 may include a state where the expression member 630 is raised at least a certain height (e.g., at least 0.6 cm) from a bottom surface 1002 of a display area of the information output apparatus 1000. The retraction actuated state of the expression member 630 may include a state where the expression member 630 is positioned at the bottom surface 1002 of the display area of the information output apparatus 1000.

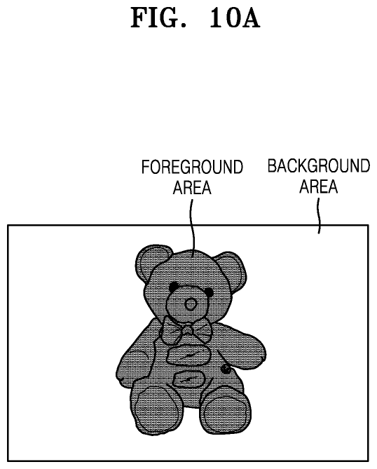

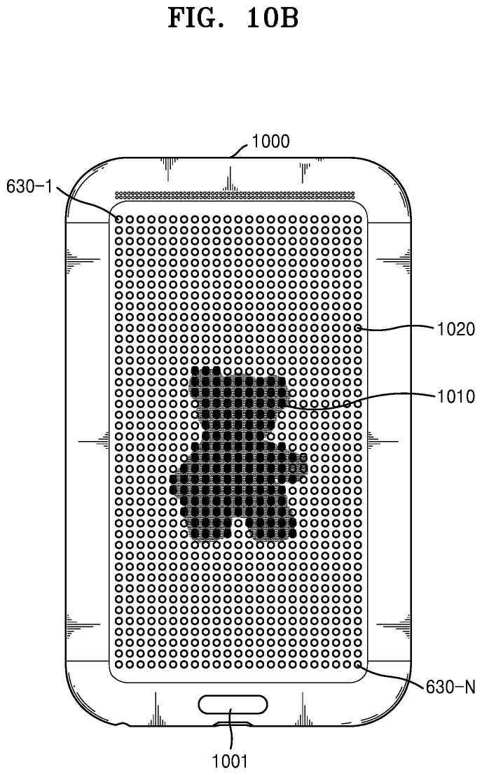

FIGS. 10A and 10B are exemplary diagrams relating to information output in the information output apparatus 1000 of FIG. 8, according to an embodiment. FIGS. 10A and 10B show the case where the information output apparatus 1000 operates in the image information output mode as the first information output mode. FIG. 10A shows image information divided into a foreground area and a background area and FIG. 10B shows a state in which the image information is output to the first through N-th expression members 630-1 through 630-N in the information output apparatus 1000. In the foreground area of the image information, at least one expression member mapped among the first through N-th expression members 630-1 through 630-N is calculated as a first activation area 1010 and actuated to protrude. In the background area of the image information, at least one mapped expression member is calculated as a second activation area 1020 and actuated to retract. A user may sense expression members actuated to protrude in the first activation area 1010 and/or expression members actuated to retract in the second activation area 1020, thereby recognizing the foreground area and the background area of the image information.

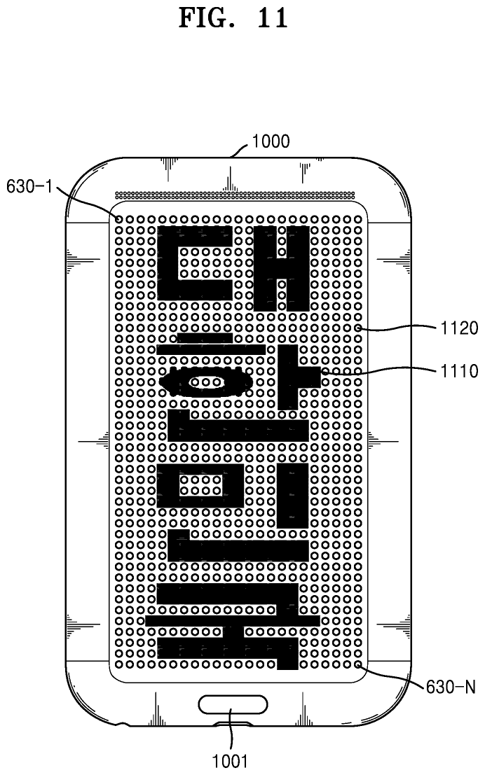

FIG. 11 is an exemplary diagram relating to information output in the information output apparatus 1000 of FIG. 8, according to another embodiment. FIG. 11 shows the case where the information output apparatus 1000 outputs text information included in image information in the first information output mode. In FIG. 11, at least one expression member mapped to text itself among the first through N-th expression members 630-1 through 630-N is calculated as a first activation area 1110 and actuated to protrude, and the other expression members mapped to a portion excluding the text are calculated as a second activation area 1120 and actuated to retract. A user may sense expression members actuated to protrude in the first activation area 1110 and/or expression member actuated to retract in the second activation area 1120, thereby recognizing the text information.

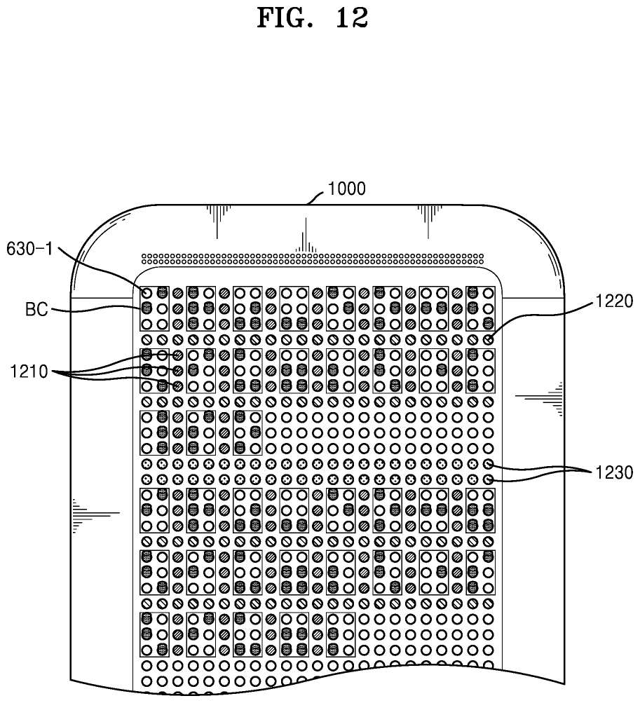

FIG. 12 is an exemplary diagram relating to information output in the information output apparatus 1000 of FIG. 8, according to another embodiment. FIG. 12 shows a state where the information output apparatus 1000 outputs braille information to expression members 630 in an activation area in the braille information output mode as the second information output mode.

A first non-activation area 1210 includes, for example, three expression members 630 arranged in three rows and one column between columns of respective braille cells BC, and it is shown that the three expression members 630 arranged in three rows and one column in the first non-activation area 1210 are maintained retracted. A second non-activation area 1220 includes, for example, an expression member 630 arranged in one row and one column between rows of respective braille cells BC, and it is shown that the expression member 630 arranged in one row and one column in the second non-activation area 1220 is maintained retracted. A third non-activation area 1230 includes, for example, expression members 630 arranged in two rows and two columns between paragraphs of braille cells BC, and it is shown that the expression members 630 arranged in two rows and two columns in the third non-activation area 1230 are maintained retracted.

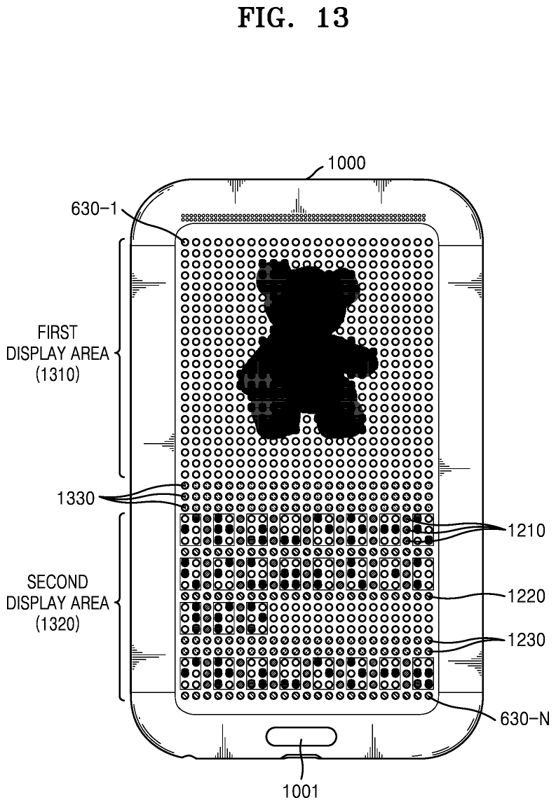

FIG. 13 is an exemplary diagram relating to information output in the information output apparatus 1000 of FIG. 8, according to another embodiment. FIG. 13 shows a case where the information output apparatus 1000 operates in the mixed information output mode as the third information output mode.

FIG. 13 shows an example in which the information output apparatus 1000 is divided into a first display area 1310 and a second display area 1320 and image information is output in the first display area 1310 via protrusion and/or retraction of expression members, and detailed descriptions thereof are the same as those given in FIG. 9 and will thus be omitted. An example in which braille information is output in the second display area 1320 via protrusion and/or retraction of expression members and retraction maintaining of expression members is shown, and detailed descriptions thereof are the same as those given in FIG. 12 and will thus be omitted. FIG. 13 shows an example in which a fourth non-activation area 1330 is further provided as a separating non-activation area. The fourth non-activation area 1330 includes, for example, expression members 630 arranged three rows and three columns in a location separating the first display area 1310 from the second display area 1320, and it is shown that the expression members 630 arranged in three rows and three columns in the fourth non-activation area 1330 are maintained retracted.

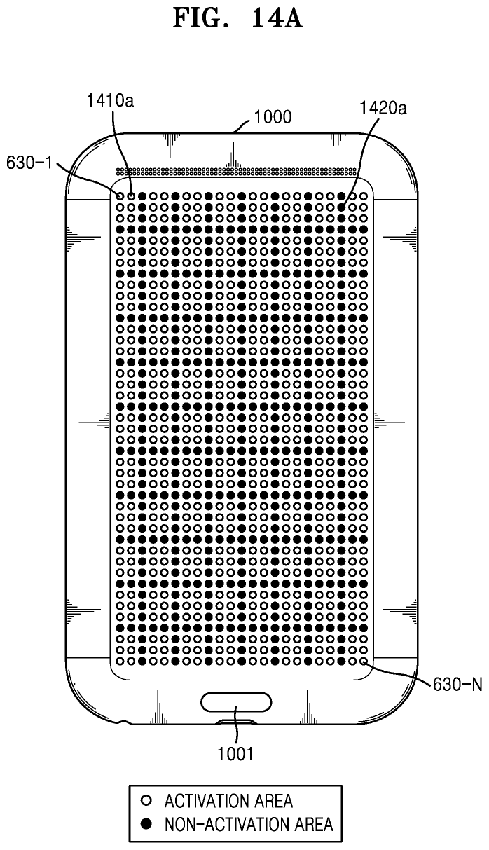

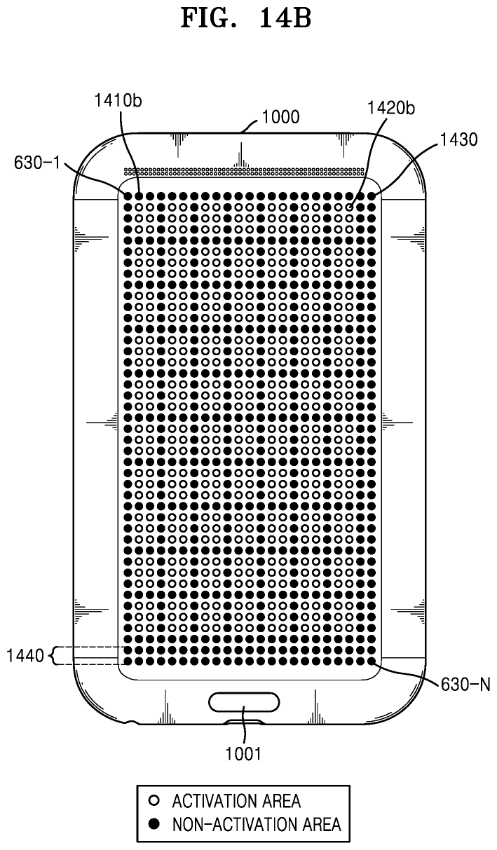

FIGS. 14A and 14B are exemplary diagrams relating to a shift result of the information output apparatus 1000, according to an embodiment. FIG. 14A shows an exemplary diagram of the information output apparatus 1000 before a shift and FIG. 14B shows an exemplary diagram of the information output apparatus 1000 after the shift. FIG. 14B shows a result of shifting an activation area and a non-activation area one column to the right and one row down in the information output apparatus 1000. When FIGS. 14A and 14B are compared with each other, it may be seen that an activation area 1410a before the shift is converted into a non-activation area 1410b after the shift and a non-activation area 1420a before the shift is converted into an activation area 1420b after the shift. In addition, when there is at least one dummy area (e.g., a column 1430 and rows 1440), which is included in an activation area but cannot form a braille cell including three rows and two columns, in FIG. 14B, the information output apparatus 1000 may convert the dummy area into the non-activation area.

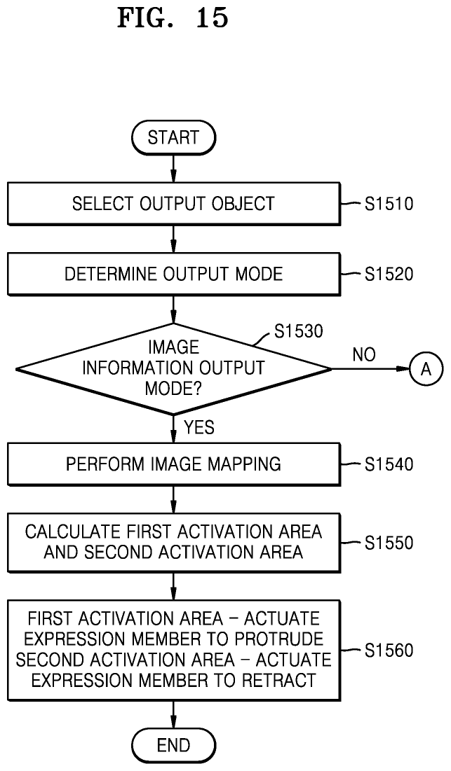

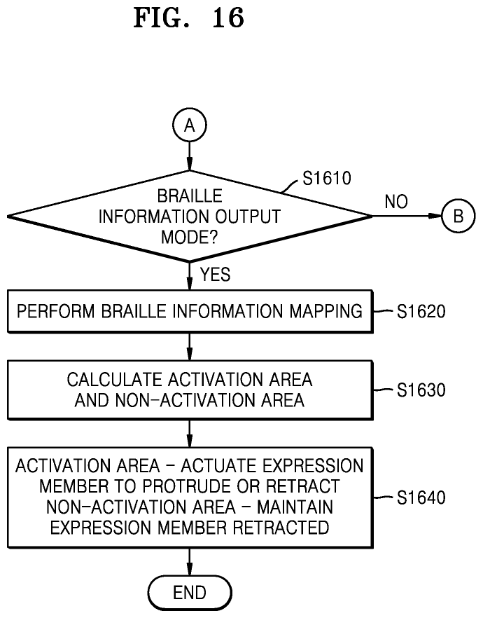

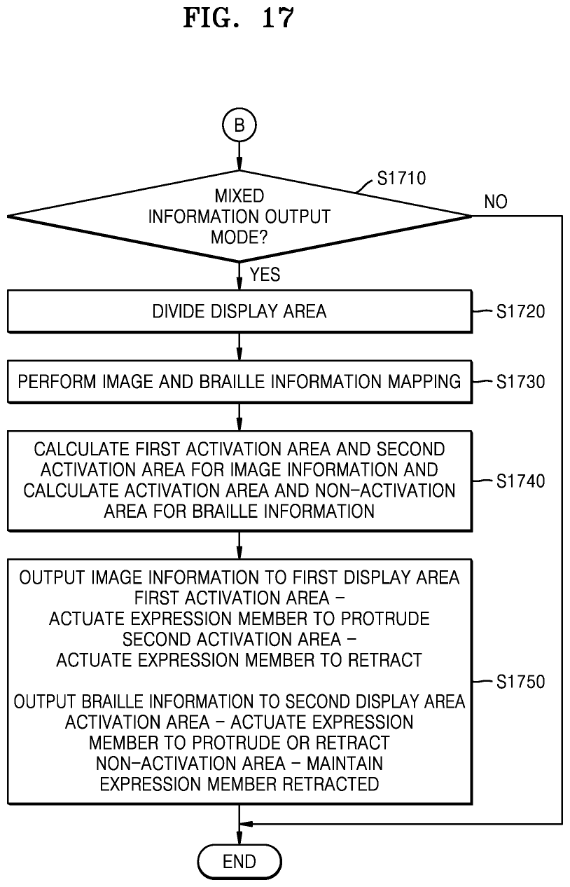

FIGS. 15 through 17 are flowcharts of an information output method according to an embodiment. Redundant descriptions given in FIGS. 1 through 14B will be omitted below. FIG. 15 is a flowchart of an information output method corresponding to the image information output mode, FIG. 16 is a flowchart of an information output method corresponding to the braille information output mode, and FIG. 17 is a flowchart of an information output method corresponding to the mixed information output mode.

Referring to FIG. 15, the information output apparatus 1000 may select an output object to be output from information externally received through the communication unit 100, information stored in the memory 200, and/or internally generated information in operation S1510.

The information output apparatus 1000 may determine an information output mode for the selected output object in operation S1520. The information output apparatus 1000 may classify the information output mode into three modes including an image information output mode as a first information output mode, a braille information output mode as a second information output mode, and a mixed information output mode (i.e., an image and braille information output mode) as a third information output mode.

The information output apparatus 1000 may determine whether the output mode is the image information output mode in operation S1530 and, when the output mode is the image information output mode, may divide image information to be output into a foreground area and a background area and map the foreground area and the background area to a plurality of expression members in the information output apparatus 1000 in operation S1540.

When the mapping is completed, the information output apparatus 1000 may calculate a first activation area, as a protrusion actuated position of each of a plurality of expression members in the foreground area, and a second activation area, as a retraction actuated position of each of a plurality of expression members in the background area, in operation S1550.

The information output apparatus 1000 may actuate an expression member to protrude for the first activation area and actuate an expression member to retract for the second activation area in operation S1560.

Referring to FIG. 16, when the output mode of the information output apparatus 1000 is the braille information output mode in operation S1610, the information output apparatus 1000 may map braille information to be output to a plurality of expression member in the information output apparatus 1000 in operation S1620.

When the mapping of the braille information is completed, the information output apparatus 1000 may calculate an activation area, as a protrusion actuated position and/or a retraction actuated position of each of a plurality of expression members included in the braille information, and a non-activation area for distinguishing braille letters, as a retraction maintained position of each of a plurality of expression members, in operation S1630. In this embodiment, the non-activation area may include first through third non-activation areas. To distinguish braille columns from each other, the information output apparatus 1000 may calculate, as the first non-activation area, for example, three expression members arranged in three rows and one column between braille columns. To distinguish braille rows from each other, the information output apparatus 1000 may calculate, as the second non-activation area, for example, an expression member arranged in one row and one column between braille rows. To distinguish braille paragraphs from each other, the information output apparatus 1000 may calculate, as the third non-activation area, for example, an array of expression members arranged in two rows and two columns between braille paragraphs.

The information output apparatus 1000 may output the braille information by actuating an expression member to protrude or retract for the activation area and actuating an expression member to retract for each of the first through third non-activation area in operation S1640.

Referring to FIG. 17, when the output mode of the information output apparatus 1000 is the mixed information output mode in operation S1710, the information output apparatus 1000 may divide an information output area into a first display area and a second display area in operation S1720.

When the division of a display area is completed, the information output apparatus 1000 may map image information to be output to a plurality of expression members in the first display area and braille information to a plurality of expression members in the second display area in operation S1730.

When the mapping of the image information and the braille information is completed, the information output apparatus 1000 may calculate a first activation area and a second activation area for the image information and an activation area and a non-activation area for the braille information in operation S1740.

The information output apparatus 1000 may actuate an expression member to protrude for the first activation area and actuate an expression member to retract for the second activation area when outputting the image information to the first display area and may actuate an expression member to protrude or retract for the activation area and maintain an expression member retracted for each of first through fourth non-activation area when outputting the braille information to the second display area in operation S1750. Here, descriptions of the first through fourth non-activation areas are the same as those given in FIGS. 14A and 14B and thus omitted. To separate the first display area from the second display area, the fourth non-activation area may include, for example, an array of expression members arranged in three rows and three columns between the first display area and the second display area.

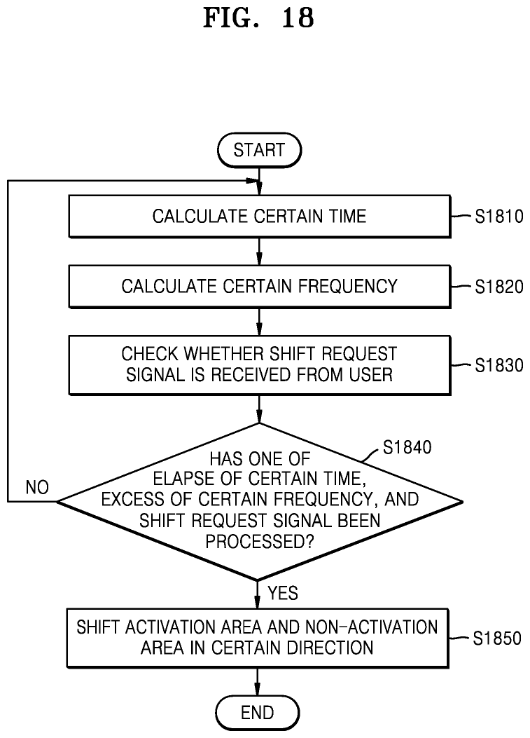

FIG. 18 is a flowchart of a shift method of an information output apparatus, according to an embodiment. Redundant descriptions given in FIGS. 1 through 17 will be omitted below.

The information output apparatus 1000 may calculate a certain time in which an activation area and a non-activation area may be shifted in operation S1810. Here, the calculation of the certain time may include counting and accumulating the certain time, and the certain time may include the first through fourth shift start times described above.

The frequency calculator 720 of the information output apparatus 1000 may calculate a certain frequency at which the activation area and the non-activation area may be shifted in the certain direction in operation S1820. Here, the calculation of the certain frequency may include counting and accumulating the certain frequency, i.e., a certain number. The certain frequency may include a protrusion actuating frequency and a retraction actuating frequency of each actuator in the activation area since the initial operation of the information output apparatus 1000.

The information output apparatus 1000 may check whether a shift request signal for shifting the activation area and the non-activation area in the certain direction is received from a user in operation S1830. Here, the information output apparatus 1000 may receive a shift direction setting signal from the user. When the shift direction setting signal is not received from the user, a programmed shift direction may be set.

The calculation of the certain time (S1810), the calculation of the certain frequency (S1820), and the checking of whether the shift request signal is received (S1830) are sequentially performed in this embodiment but may be simultaneously performed in parallel.

The information output apparatus 1000 may determine whether one of an elapse of the certain time, an excess of the certain frequency, and the user's shift request signal has been processed in operation S1840.

The information output apparatus 1000 may substantially shift the activation area and the non-activation area in the certain direction in response to the elapse of the certain time, the excess of the certain frequency, and the user's shift request signal in operation 51850. Here, the certain direction may include a programmed horizontal direction shifting by at least one column or a programmed vertical direction shifting by at least one row. As described above, the certain direction may further include the number of columns and/or the number of rows, that is, the amount of shift, together with a direction. The certain direction may include a direction in which a previous activation area is converted into a non-activation area after the shift.

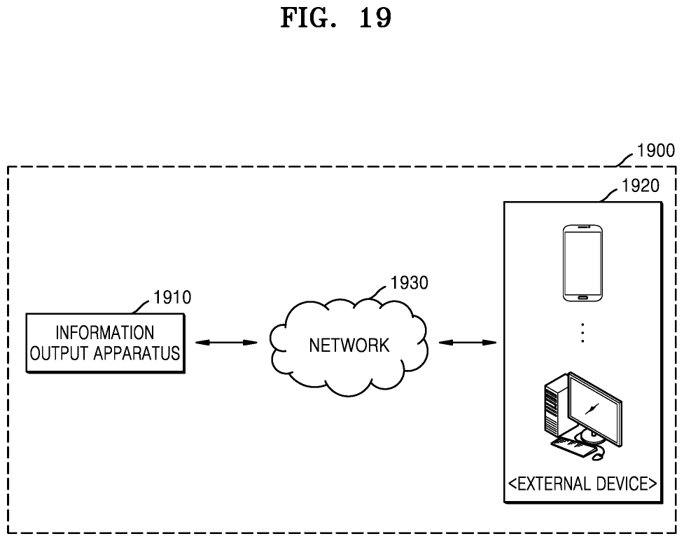

FIG. 19 is a diagram of an example of an information output system including an information output apparatus, according to an embodiment.

Referring to FIG. 19, an information output system 1900 may include an information output apparatus 1910, an external device 190, and a network 1930.

The information output apparatus 1910 may have compatibility with the external device 190 and may output tactile information based on compatibility information received from the external device 190. That is, the information output apparatus 1910 may be an electronic device that is capable of outputting braille-based tactile information for visually impaired users. For example, the information output apparatus 1910 may include a braille watch, a braille pad, etc.

Here, having compatibility may refer to that the information output apparatus 1910 receives information on the external device 190 and is allowed to smoothly communicate with the external device 190 based on the analysis result of the information. The information on the external device 190 may include, for example, the type, specification information, operation information, etc. of the external device 190. The type of external device may refer to any one of a screen reading device, an interactive information processing device, and a text reading device. The specification information on the external device 190 may include, for example, device information related to a tablet PC, PC, smartphone, or dedicated terminal, the type of user interface in the device information, the size of the user interface, functions supported in the device, etc. The operation information on the external device 190 may include, for example, control signals for implementing functions, a communication method with the information output apparatus 1910, etc.

Furthermore, having compatibility may refer to that the external device 190 can generate compatibility information based on information on the information output apparatus 1910 and transmit it to the information output apparatus 1910, and the information output apparatus 1910 can output the compatibility information received from the external device 190 without any special settings. The information on the information output apparatus 1910 may be, for example, specification information, operation information, etc. related to the information output apparatus 1910. The specification information on the information output apparatus 1910 may include, for example, the number of information output portions, the size of each information output portion, and the number of information output units included in the information output portion. The operation information on the information output apparatus 1910 may include, for example, operating power, signals necessary for actuating information output units to protrude or retract, a communication method with the external device 190, and the like.

In an embodiment, compatibility information may include one of a series of information sets that are processed to output visual information, audio information, files, etc., output from the external device 190, as tactile information to the information output apparatus 1910. Tactile information output in the information output apparatus 1910 and control signals generated in the information output apparatus 1910 to control the external device 190 may also be included in compatibility information.

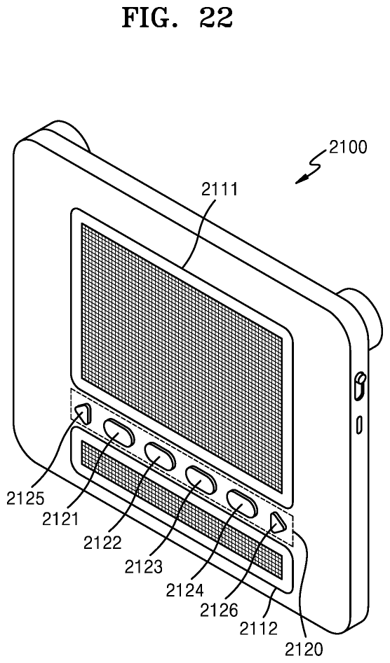

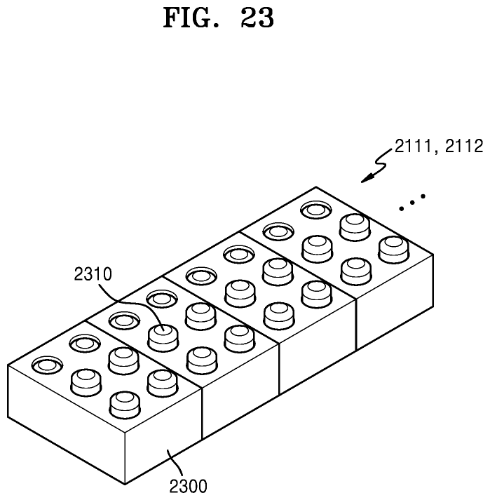

In an embodiment, the information output apparatus 1910 may output tactile information to a first information output portion (311 in FIG. 22) and a second information output portion (312 in FIG. 22). In this regard, the information output apparatus 1910 may output tactile information by actuating one more information output units (2310 in FIG. 23) to protrude or retract.

In addition, the information output apparatus 1910 may change tactile information based on compatibility information or control the operation of the external device 190 by performing functions corresponding to one or more selected operation keys, in response to a selection input with respect to a plurality of operation keys.

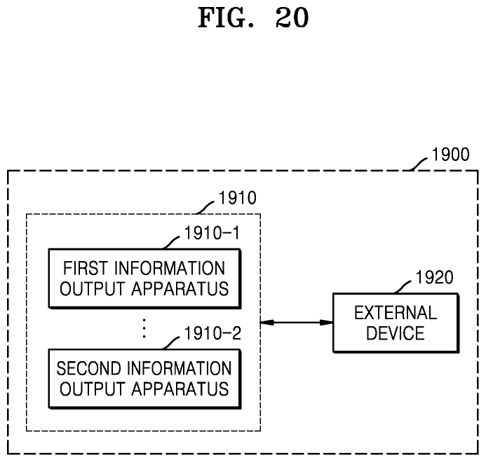

In an embodiment, there may be more than one information output apparatus 1910. As shown in FIG. 20, a plurality of information output apparatuses 1910-1 and 1910-2 may be connected to the external device 190. In this regard, in a state where the first information output apparatus 1910-1 is connected to the external device 190, when connection of another information output apparatus, i.e., the second information output apparatus 1910-2 to the external device 190 is received, the performance of functions of some of a plurality of operation keys may be restricted.

The external device 190 may be a screen reading device, an interactive information processing device, and a text reading device, but is not limited thereto.

A screen reading device may read a screen to generate screen information on objects (e.g., icons) displayed on the screen, and output the screen information in various ways (e.g., using voice, text, or braille letters), to help visually impaired people easily perceive the screen information. The screen reading device may process the screen information to be perceivable in the information output apparatus 1910 to transmit as compatibility information to the information output apparatus 1910, and may operate according to a control signal generated by the information output apparatus 1910 based on the compatibility information.

An interactive information processing device may output information related to its operation as visual data through a display. Here, the display may be interlayered or integrated with a touch sensor to be implemented as a touch screen. The touch screen may function as a user input unit that provides an input interface to a user, and is referred to herein as a user interface panel.

The user interface panel is a configuration, through which information related to the interactive information processing device may be input and output, and may refer to a control panel enabling input and output of information.

The user interface panel may be, for example, a display member such as an organic light emitting display (OLED), a liquid crystal display (LCD), or a light emitting display (LED), which is touch-sensitive.

The interactive information processing device may receive various types of information (e.g., texts, images) from a user through the user interface panel. The user interface panel may have an area divided into a plurality of grid cells.

The interactive information processing device may process various types of information, input from a user, to be perceivable in the information output apparatus 1910 to transmit as compatibility information to the information output apparatus 1910, and may operate according to a control signal generated by the information output apparatus 1910 based on the compatibility information.

A text reading device may generate text information by reading text (or an image) through a camera (or scanner). The text reading device may process text information to be perceivable in the information output apparatus 1910 to transmit as compatibility information to the information output apparatus 1910, and may operate according to a control signal generated by the information output apparatus 1910 based on the compatibility information.

The external device 190 may be a dedicated terminal that supports any one of the functions of reading a screen, processing various types of information input through a user interface panel, which includes an area divided into a plurality of grid cells, and reading a text, but is not limited to this and may be a user terminal having functions each implemented in the form of application or software.

Here, the user terminal may include a communication terminal capable of performing the functions of a computing device, and may be a device operated by a user, examples of which may include desktop computers, smartphones, laptops, tablet PCs, smart TVs, portable phones, personal digital assistants (PDAs), media players, micro servers, global positioning system (GPS) devices, e-book terminals, digital broadcasting terminals, navigators, kiosks, MP3 players, digital cameras, home appliances, and other mobile or non-mobile computing devices, but is not limited thereto. The user terminal is not limited to the above-described content, and any terminal capable of supporting web browsing may be used without limitation.

The network 1930 may serve to connect the information output apparatus 1910 to the external device 190. The network 1930 may be, for example, a wired network such as a local area network (LAN), a wide area network (WAN), a metropolitan area network (MAN), or an integrated service digital network (ISDN), etc. and a wireless network such as a wireless LAN (WLAN), a code division multiple access (CDMA), satellite communication, etc., but the scope of the present disclosure is not limited thereto. Additionally, the network 1930 may transmit and receive information using short-range communication and/or telecommunication. Here, short-range communication technologies may include Bluetooth, radio frequency identification (RFID), infrared data association (IrDA), ultra-wideband (UWB), ZigBee, and Wi-Fi, and telecommunication technologies may include code-division multiple access (CDMA), frequency-division multiple access (FDMA), time-division multiple access (TDMA), orthogonal frequency-division multiple access (OFDMA), and single carrier frequency-division multiple access (SC-FDMA).

The network 1930 may include connections of network elements such as hubs, bridges, routers, and switches. The network 1930 may include one or more connected networks, for example, multi-network environment including public networks, such as the Internet, and private networks, such as a secure private network of corporation. Access to the network 1930 may be made through one or more wired or wireless access networks.

Furthermore, the network 1930 may support technologies of controller area network (CAN) communication, vehicle to infrastructure (V2I) communication, vehicle to everything (V2X) communication, wireless access in vehicular environment (WAVE) communication, Internet of Things (IoT) network of processing information exchanged between dispersed components such as things or the like, and/or 5G communication.

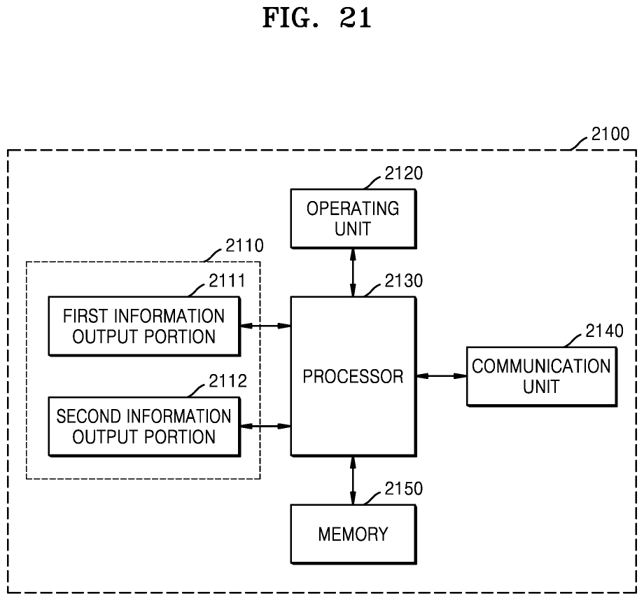

FIG. 21 is a diagram of an example of the configuration of an information output apparatus, according to an embodiment, and FIG. 22 is a schematic diagram of appearance of the information output apparatus, according to an embodiment.

Referring to FIGS. 21 and 22, an information output apparatus 2100 according to an embodiment may include an information output part 2110, an operating unit 2120, a processor 2130, a communication unit 2140, and a memory 2150.

The information output part 2110 may include a first information output portion 2111 and a second information output portion 2112.

The first information output portion 2111 may output first tactile information by actuating one or more first information output units (510 in FIG. 23) to protrude or retract.

The second information output portion 2112 may be disposed at a different position from the first information output portion and output first tactile information by actuating one or more second information output units (510 in FIG. 23) to protrude or retract.

The operating unit 2120 may include a plurality of operation keys. For example, as shown in FIG. 22, the operating unit 2120 may include a left operation key 2125, a first operation key 2121, a second operation key 2122, a third operation key 2123, a fourth operation key 2124, and a right operation key 2126.

As a compatible external device is connected, the processor 2130 may receive compatibility information from the external device. Here, the compatibility information may be, for example, an image (photo, video, graph, etc.) or text.

The processor 2130 may generate an actuation signal for one or more of the first information output units and the second information output units based on the compatibility information received from the external device, and transmit the generated actuation signal to one or more of the first information output portion 2111 and the second information output portion 2112, enabling output of tactile information regarding the compatibility information.

In this regard, the processor 2130 may generate a first actuation signal for actuating the first information output units in the first information output portion 2111 based on an image extracted from the compatibility information received from the external device, and a second actuation signal for actuating the second information output units in the second information output portion 2112 based on a text extracted from the compatibility information. Here, the processor 2130 may generate the second actuation signal based on a braille table stored in the memory 2150.

The processor 2130 may transmit the first actuation signal and the second actuation signal to the first information output portion 2111 and the second information output portion 2112, respectively, to output tactile information related to the image through the first information output portion 2111, and tactile information related to the text through the second information output portion 2112, thereby facilitating various types of information to be perceived through tactile sensation.

In an embodiment, the processor 2130 may output tactile information related to an image through the first information output portion 2111, but is not limited to this and may also output tactile information related to text along with the image. As an image and first text and second text describing the image are extracted from the compatibility information, the processor 2130 may divide the first information output portion 2111 into a first sub-information output portion and a second sub-information output portion. The processor 2130 may then generate a 1-1th actuation signal that actuates first information output units included in any one of the first sub-information output portion and the second sub-information output portion, on the basis of the image. Here, the first text and the second text may differ in text properties (e.g., name referring to the image, additional description of the image, etc.), size, font, language, etc.

The processor 2130 may generate a 1-2th actuation signal for actuating first information output units included in the other of the first sub-information output portion and the second sub-information output portion, based on the first text, while generating a second actuation signal for actuating second information output units included in the second information output portion 2112, based on the second text. The processor 2130 may output tactile information on the text (the first and second texts) through a partial area of the first information output portion 2111 and the second information output portion 2112, thereby providing a relatively large quantity of tactile information on the text, compared to when outputting tactile information on the text through the second information output portion 2112.

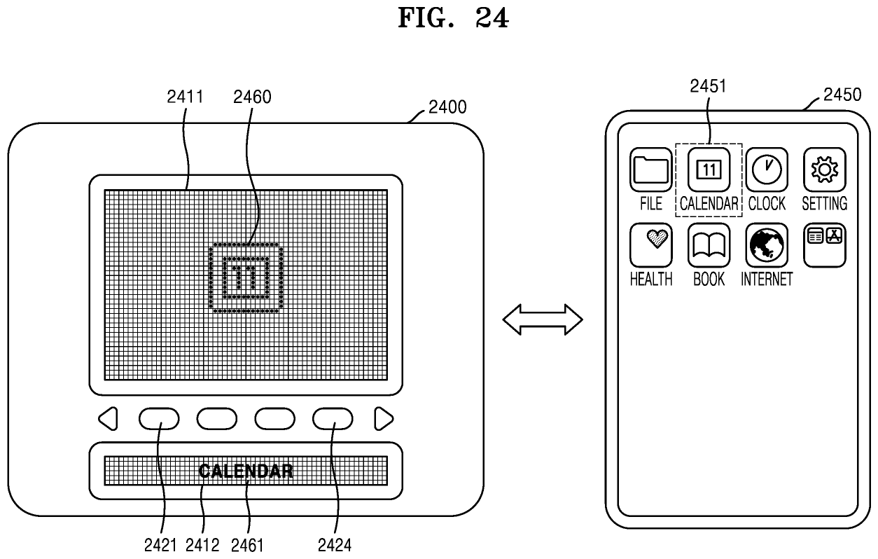

In an embodiment, the processor 2130 may perform functions corresponding to one or more operation keys selected from among the plurality of operation keys. In this regard, the processor 2130 may change one or more of first tactile information output to the first information output portion 2111 and second tactile information output to the second information output portion 2112 based on compatibility information, according to one or more operation keys selected from among the plurality of operation keys. Additionally, the processor 2130 may control the operation of an external device according to one or more operation keys selected from among the plurality of operation keys. In this regard, the processor 2130 may perform a function corresponding to the same operation key differently depending on the type of external device. Here, for convenience of explanation, functions performed in response to one or more operation keys will be described in detail later with reference to FIGS. 24 through 33.

In an embodiment, the processor 2130 may perform a function corresponding to a single operation key, in response to the selection of the single operation key, and perform functions corresponding to a plurality of operation keys (combination key), in response to the selection of the plurality of operation keys. That is, the processor 2130 may perform a first function corresponding to a first operation key in response to selection of the first operation key, and perform a second function corresponding to a combination of the first operation key and a second operation key (combination key) in response to selection of the second operation key together with the first operation key. Here, the first operation key may refer to any one operation key among the plurality of operation keys, and the second operation key may refer to another operation key among the plurality of operation keys.

In addition, the processor 2130 may not only perform a different function depending on the type of operation key selected (e.g., first operation key, second operation key, etc.), but also perform a different function depending on a touch holding time for an operation key.

For example, the processor 2130 may initialize the information output apparatus 2100 as a left operation key and a right operation key are selected from among the plurality of operation keys for a touch holding time less than a preset threshold. In addition, the processor 2130 may check remaining battery power of the information output apparatus 2100 as the left operation key and the right operation key are selected from among the plurality of operation keys for a touch holding time equal to or longer than the preset threshold, and output a result of the check to any one of the first information output portion 2111 and the second information output portion 2112.

Meanwhile, when a connection of another information output apparatus to an external device is received in a state where the information output apparatus is connected to the external device, the processor 2130 may restrict the performance of functions of some of the plurality of operation keys, thereby suppressing malfunctioning of the external device which is caused due to different controls for the external device by a plurality of information output apparatuses.

The communication unit 2140 may be configured to transmit a signal between an external device (e.g., an information providing server or another information output apparatus) and the information output apparatus 2100 in association with the network (1930 of FIG. 19) and may provide a communication interface needed to provide a transmission/reception signal in a form of packet data. Furthermore, the communication unit 2140 may receive a certain information request signal from the information output apparatus 2100 and transmit information processed by the information output apparatus 2100 to outside the information output apparatus 2100. Here, the network is a medium connecting an external device to the information output apparatus 2100 and may include a channel providing an access route such that the information output apparatus 2100 may transmit and receive data after accessing the external device.

The memory 2150 may store codes, which cause the processor 2130 to support various functions of an external device when the external device is connected to the processor 2130 and executed by the processor 2130. That is, the memory 2150 may store information related to an external device, a number of application programs (or applications) running on the external device, information for operating the external device, and instructions. At least some of applications may be downloaded from an external server via wireless communication.

The memory 2150 may be equipped with software for a series of processing processes performed by the processor 2130.

Additionally, the memory 2150 may further store braille tables. The braille tables may include, for example, braille letters for the Braille writing system consisting of abbreviations (articles, . . . , but, therefore, thus, etc.), numbers (1, 2, 3, . . . , 0), signs (?, !, +, etc.), English alphabets (A, B, C, . . . , Z), etc.

The memory 2150 may temporarily or permanently store Information processed by the processor 2130 and/or information externally received through the communication unit 2140. Here, the memory 2150 may include a magnetic storage medium or a flash storage medium, but the scope of the present disclosure is not limited thereto. The memory 2150 may include internal memory and/or external memory, and include a storage medium, which includes a volatile memory such as DRAM, SRAM, or SDRAM, a non-volatile memory such as one time programmable ROM (OTPROM), PROM, EPROM, EEPROM, mask ROM, flash ROM, NAND flash memory, NOR flash memory, etc., flash drive such as SSD, compact flash (CF) card, SD card, Micro-SD card, Mini-SD card, Xd card, memory stick, etc., or a storage device such as HDD.

FIG. 23 is a diagram of information output cells included in the first information output portion and the second information output portion within the information output apparatus, according to an embodiment.

Referring to FIG. 23, the first information output portion 2111 and the second information output portion 2112 may each have a plurality of information output cells 2300 (2300_1 through 2300_N). Here, the first information output portion 2111 and the second information output portion 2112 may have different sizes and each include a different number of information output cells. For example, the size of the first information output portion 2111 may be larger than the size of the second information output portion 2112. Therefore, the number of information output cells in the first information output portion 2111 may be greater than the number of information output cells in the second information output portion 2112. In one embodiment, the first information output portion 2111 may include a total of 300 information output cells 500, corresponding to 30×10 cells, and the second information output portion 2112 may include a total of 20 information output cells 500, corresponding to 20×1 cells, but the numbers are not limited thereto, and more information output cells 2300 may be included in each portion.

Tactile information (e.g., braille information) output to the first information output portion 2111 and the second information output portion 2112 may be output in a unit of information output cell 2300 including information output units 2310 arranged in 3 rows and 2 columns. When applied to this embodiment, each information output cell 2300 may include six information output units 2310.

In this embodiment, one information output cell 500 is limited to including six information output units 510, but is not limited to this.

FIGS. 24 through 26 are diagrams of an example of controlling an external device in an information output apparatus, according to an embodiment.

Referring to FIG. 24, the processor of an information output apparatus 2400 may be connected to a screen reading device 2450, as a compatible external device, which reads a screen, and may receive compatibility information, for example, information on an icon from the screen reading device 2450. In response to the reception of the information on the icon, the processor may extract an image for the icon and text for the icon from the information on the icon. The processor may generate a first actuation signal for actuating first information output units in a first information output portion 2411, based on the image for the icon, and transmit the generated first actuation signal to the first information output portion 2411, thereby outputting tactile information regarding the image for the icon. The processor may generate a second actuation signal for actuating second information output units in a second information output portion 2412, based on the text for the icon, and transmit the generated second actuation signal to the second information output portion 2412, thereby outputting tactile information regarding the text for the icon. For example, the processor may receive information related to a ‘Calendar’ icon, on which a cursor 2451 is located on a screen, from the screen reading device 2450. When an image 2460 for the ‘Calendar’ icon and a text 2461 for the ‘calendar’ icon are extracted from the information on the ‘Calendar’ icon, the processor may generate a first actuation signal for actuating first information output units included in the first information output portion 2411, based on the image 2460 for the ‘Calendar’ icon, and transmit the generated first actuation signal to the first information output portion 2411. In addition, the processor may generate a second actuation signal for actuating second information output units included in the second information output portion 2412, based on the text 2461 for the ‘Calendar’ icon, and transmit the generated second actuation signal to the second information output portion 2412. The processor may output both tactile information regarding the image for the ‘Calendar’ icon and tactile information regarding the text for the ‘Calendar’ icon, making it easier to perceive the ‘Calendar’ icon through tactile sensation.

In this regard, the processor may control the cursor 2451 on the screen of the screen reading device 2450 to move in a first direction (e.g., to the left, upward) or a second direction (e.g., to the right, downward) according to selection of an operation key.

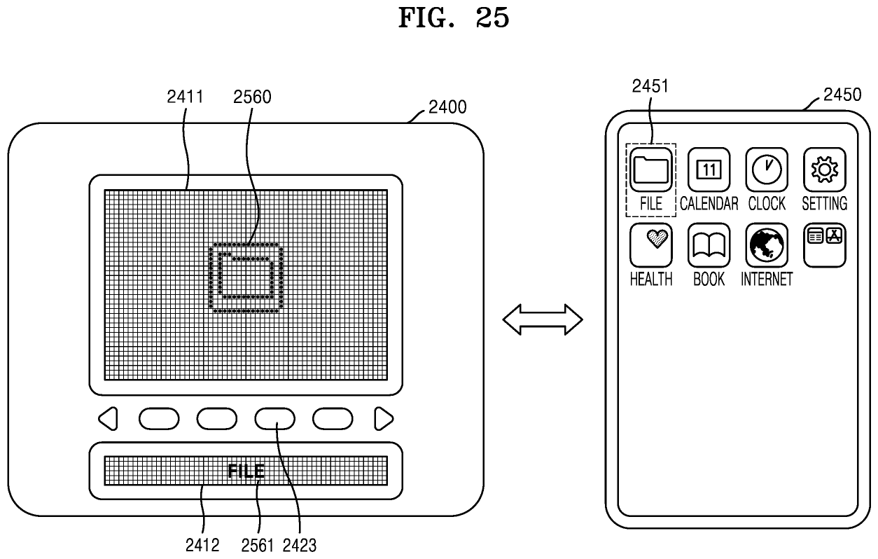

In an embodiment, when a first operation key 2421 is selected from among a plurality of operation keys for a touch holding time less than a preset threshold (e.g., less than 1500 ms), the processor may control the cursor on the screen within the screen reading device 2450 to move in a first direction (e.g., to the left). For example, when the first operation key 2421 is selected for the touch holding time less than the threshold in a state where the cursor 2451 is located on the ‘Calendar’ icon (see FIG. 24), the processor, as shown in FIG. 25, may control the cursor 2451 to move to the left to be located on a ‘File’ icon. In this regard, the processor may receive information related to the ‘File’ icon, on which the cursor 2451 is located on the screen, from the screen reading device 2450. When an image 2560 for the ‘File’ icon and a text 2561 for the ‘File’ icon are extracted from the information on the ‘File’ icon, the processor may generate a first actuation signal for actuating first information output units included in the first information output portion 2411, based on the image 2560 for the ‘File’ icon, and transmit the generated first actuation signal to the first information output portion 2411. In addition, the processor may generate a second actuation signal for actuating second information output units included in the second information output portion 2412, based on the text 2561 for the ‘File’ icon, and transmit the generated second actuation signal to the second information output portion 2412. The processor may output both tactile information regarding the image for the ‘File’ icon and tactile information regarding the text for the ‘File’ icon, making it easy to perceive that the icon where the cursor is located by the movement to the left is the ‘File’ icon.

Here, the processor may control an object, for example, the ‘File’ icon corresponding to the moved cursor 2451 to be open, in response to the selection of a third operation key 2423 from among the plurality of operation keys for a touch holding time less than a preset threshold.

In an embodiment, when a fourth operation key 2424 is selected from among the plurality of operation keys for a touch holding time less than a preset threshold (e.g., less than 1500 ms), the processor may control the cursor on the screen within the screen reading device 2450 to move in a second direction (e.g., to the right). As an image and first text and second text describing the image are extracted from compatibility information, the processor may divide the first information output portion 2411 into a first sub-information output portion and a second sub-information output portion. The processor may then generate a 1-1th actuation signal that actuates first information output units included in any one of the first sub-information output portion and the second sub-information output portion, on the basis of the image. The processor may generate a 1-2th actuation signal for actuating first information output units included in the other of the first sub-information output portion and the second sub-information output portion, based on the first text, while generating a second actuation signal for actuating second information output units included in the second information output portion 2412, based on the second text.

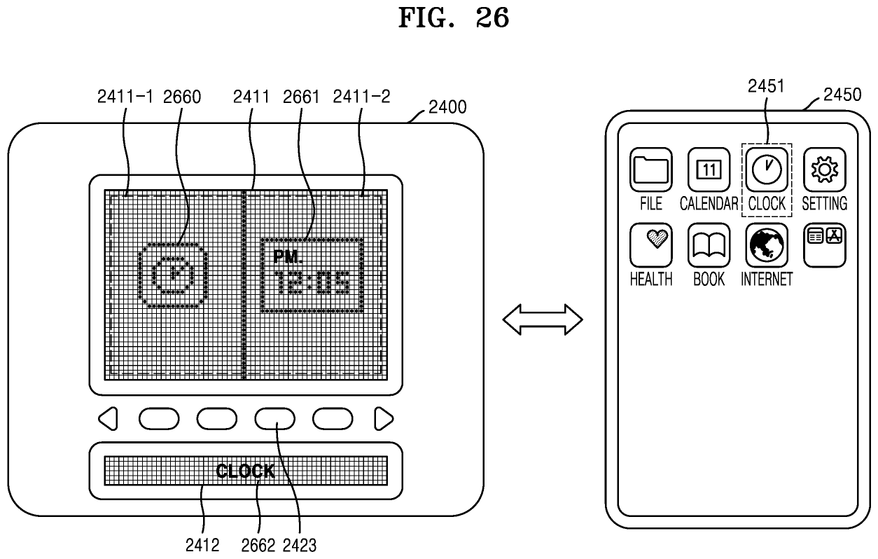

For example, when the fourth operation key 2424 is selected for a touch holding time less than a threshold in a state where the cursor 2451 is located on the ‘Calendar’ icon (see FIG. 24), the processor, as shown in FIG. 26, may control the cursor 2451 to move to the right to be located on a ‘Clock’ icon (or ‘Alarm’ icon). In this regard, the processor may receive information related to the ‘Clock’ icon, on which the cursor 2451 is located on the screen, from the screen reading device 2450. As an image 2660 for the ‘Clock’ icon and first text 2661 and second text 2662 for the ‘Clock’ icon are extracted from information on the ‘Clock’ icon, the processor may divide the first information output portion 2411 into a first sub-information output portion 2411-1 and a second sub-information output portion 2411-2. The processor may generate a 1-1th actuation signal for actuating first information output units included in the first sub-information output portion 2411-1, based on the image 2660 for the ‘clock’ icon, and may generate a 1-2th actuation signal for actuating first information output units included in the second sub-information output portion 2411-2, based on the first text 2661 for the ‘Clock’ icon. The processor may then transmit the 1-1th actuation signal and the 1-2th actuation signal to the first information output portion 2411.

In addition, the processor may generate a second actuation signal for actuating second information output units included in the second information output portion 2412, based on the second text 2662 for the ‘Clock’ icon, and transmit the generated second actuation signal to the second information output portion 2412. The processor may output both tactile information regarding the image for the ‘Clock’ icon and tactile information regarding the text for the ‘Clock’ icon, making it easy to perceive that the icon where the cursor is located by the movement to the right is the ‘Clock’ icon and also to check a current time.

Here, the processor may control an object, for example, the ‘clock’ icon corresponding to the moved cursor 2451 to be open, in response to the selection of a third operation key 2423 from among the plurality of operation keys for a touch holding time less than a preset threshold.

As described with reference to FIGS. 24 to 26, the processor of the information output apparatus 2400 may receive and output information related to an icon that changes, in response to the movement of a cursor located on an icon based on a home screen of the screen reading device 2450, but is limited to this. The processor of the information output apparatus 2400 may receive and output information related to a text that changes, in response to the movement of a cursor present on a text based on various screens, for example, a message input screen.

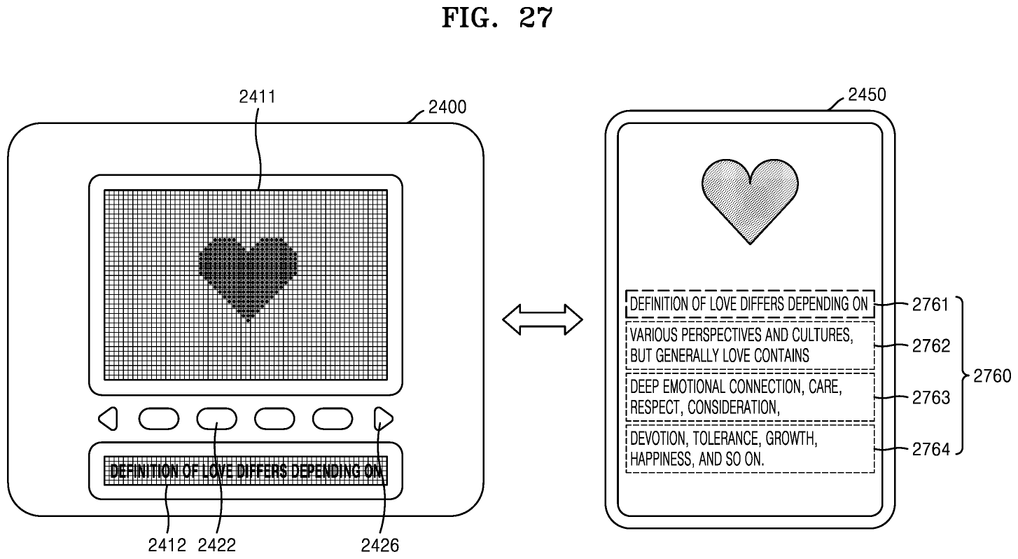

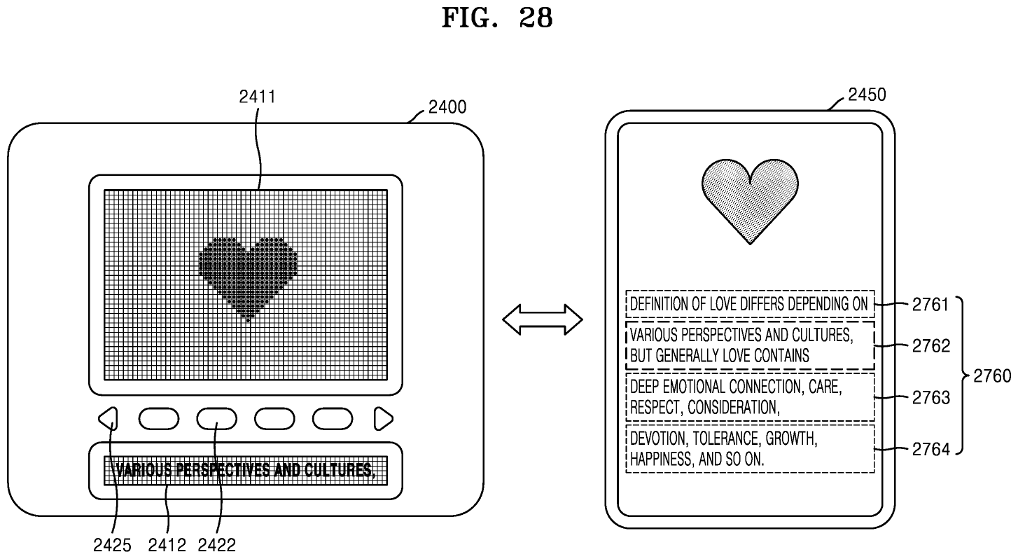

FIGS. 27 and 28 are diagrams of an example of controlling the external device in the information output apparatus, according to an embodiment.

Referring to FIG. 27, the processor of an information output apparatus 2400 may be connected to a screen reading device 2450, as a compatible external device, which reads a screen, and may receive compatibility information from the screen reading device 2450. Here, the external device is not limited to the screen reading device 2450.

The processor may receive, as compatibility information, for example, any one of file information output when a ‘file’ icon is executed, book information output when a ‘book’ icon is executed, and search information output when an ‘Internet’ icon is executed, from the screen reading device 2450 (see FIG. 25).

As an image (e.g., a heart image) and a text (e.g., a description of the heart) are extracted from the compatibility information received from the screen reading device 2450, the processor may generate a first actuation signal for actuating first information output units included in the first information output portion 2411 based on the image, and generate a second actuation signal for actuating second information output units included in the second information output portion 2412 based on the text. The processor may transmit the first actuation signal to the first information output portion 2411 and the second actuation signal to the second information output portion 2412, such that tactile information related to the image may be output through the first information output portion 2411 and tactile information related to the text may be output through the second information output portion 2412.

In an embodiment, upon outputting tactile information related to a text through the second information output portion 2412, if it is impossible to output a full text at once to the second information output portion 2412 due to a large quantity of texts (or many syllables or words), the processor may support a text movement function to enable checking of the full text. First, as it is determined that a text 960 extracted from compatibility information exceeds an output range of the second information output portion 2412, the processor may divide the text 960 into a plurality of subtext columns 2761 to 2764. The processor may generate a second actuation signal for actuating second information output units based on any one of the plurality of subtext columns 2761 to 2764, for example, a first subtext column 2761, and transmit the generated second actuation signal to the second information output portion 2412, to output tactile information regarding the first subtext column 2761. Here, the subtext columns may be within the output range of the second information output portion 2412.

In this regard, in a state where the tactile information regarding the first subtext column 2761 is output, when a right operation key 2426 is selected from among a plurality of operation keys for a touch holding time less than a preset threshold, the processor may change the second actuation signal based on a subtext column of the next order with respect to the first subtext column 2761, for example, a second subtext column 2762. As shown in FIG. 28, the processor may transmit the second actuation signal, which has changed based on the second subtext column 2762, to the second information output portion 2412, to output tactile information regarding the second subtext column 2762.

In this regard, in a state where the tactile information regarding the second subtext column 2762 is output, when a left operation key 2425 is selected from among the plurality of operation keys for a touch holding time less than a preset threshold, the processor may change the second actuation signal based on a subtext column of a previous order with respect to the second subtext column 2762, for example, the first subtext column 2761. The processor may transmit the second actuation signal, which has changed based on the first subtext column 2761, to the second information output portion 2412, to output tactile information regarding the first subtext column 2761.

That is, the processor may change the subtext columns when the left operation key 2425 and the right operation key 2426 are selected, allowing the full text to be confirmed through the text movement function. Here, the processor may support the text movement in the second information output portion 2412 in units of the subtext columns divided based on the output range of the second information output portion 2412, but is not limited to this and may support text movement based on a set unit (e.g., a preset number of syllables, sentences, information output cells, etc.).

In addition, the processor may control a home screen (e.g., FIG. 24) to be displayed on the screen reading device 2450 when a second operation key 2422 is selected from among the plurality of operation keys for a touch holding time less than a preset threshold.

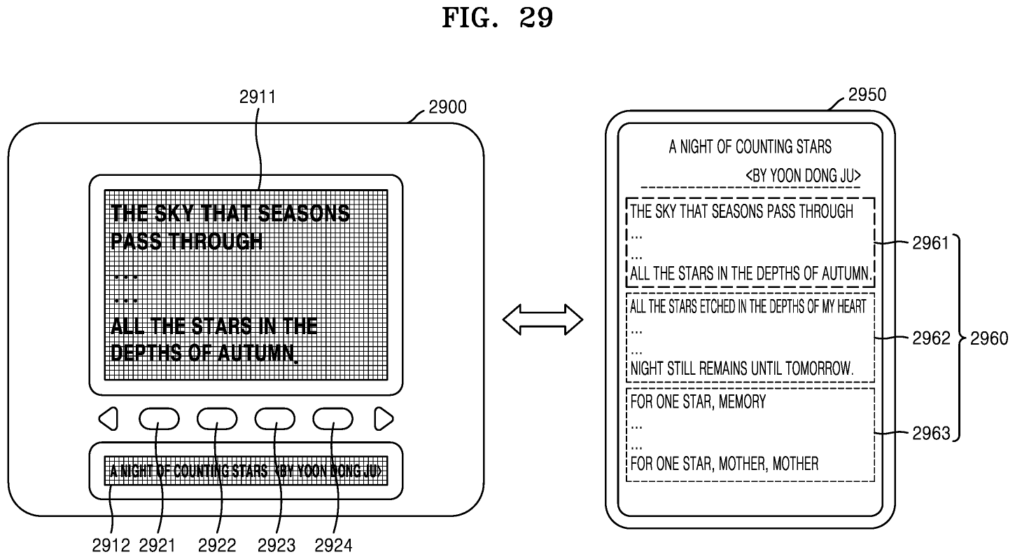

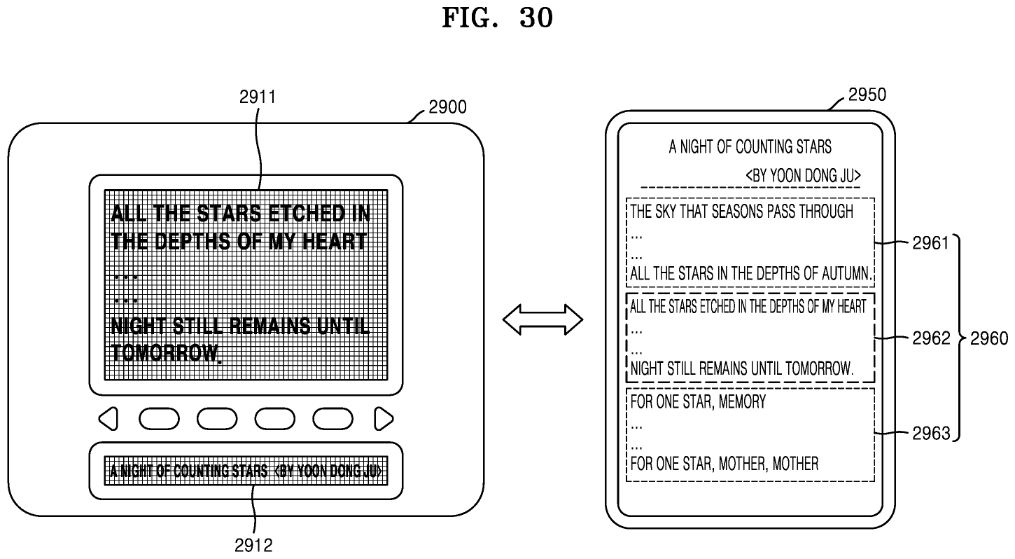

FIGS. 29 and 30 are diagrams of another example of controlling an external device in an information output apparatus according to an embodiment.

Referring to FIG. 29, the processor of an information output apparatus 2900 may be connected to a text reading device 2950, as a compatible external device, which reads a text, and may receive compatibility information from the text reading device 2950. Here, the external device is not limited to the text reading device 2950.

As a first text and a second text associated with the first text are extracted from compatibility information received from the text reading device 2950, the processor may generate a first actuation signal for actuating first information output units included in a first information output portion 2911 based on the first text, and generate a second actuation signal for actuating second information output units included in a second information output portion 2912 based on the second text. The processor may transmit the first actuation signal to the first information output portion 2911 and the second actuation signal to the second information output portion 2912, such that tactile information related to the first text may be output through the first information output portion 2911 and tactile information related to the second text may be output through the second information output portion 2912.

In an embodiment, upon outputting the tactile information related to the first text through the first information output portion 2911, if it is impossible to output a full text at once to the first information output portion 2911 due to a large quantity of texts (or many syllables, words, or sentences), the processor may support a movement function of the first text to enable viewing of the full text.

For example, the processor may receive ‘A night of counting stars (poem by Yoon Dong-Ju)’ as compatibility information, and may extract a first text 2960 regarding ‘the content of the poem’ and a second text regarding ‘the title of the poem (or, background of the poem, poet information)’ from the compatibility information. In this regard, as it is determined that the first text 2960 extracted from the compatibility information exceeds the output range of the first information output portion 2911, the processor may divide the first text 2960 into a plurality of subtext columns 2961 to 2963. The processor may generate a first actuation signal for actuating first information output units based on one of the plurality of subtext columns 2961 to 2963, for example, a first subtext column 2961, and transmit the generated first actuation signal to the first information output portion 2911, to output tactile information regarding the first subtext column 2961. Here, the subtext columns may be within the output range (the number of information output cells) of the first information output portion 2911.

In this regard, in a state where the tactile information regarding the first subtext column 2961 is output, when a fourth operation key 2924 is selected from among a plurality of operation keys for a touch holding time less than a preset threshold, the processor may change the first actuation signal based on a subtext column of the next order with respect to the first subtext column 2961, for example, a second subtext column 2962. As shown in FIG. 30, the processor may transmit the first actuation signal, which has changed based on the second subtext column 2962, to the first information output portion 2911, to output tactile information regarding the second subtext column 2962.

In this regard, in a state where the tactile information regarding the second subtext column 2962 is output, when a first operation key 2921 is selected from among the plurality of operation keys for a touch holding time less than a preset threshold, the processor may change the first actuation signal based on a subtext column of a previous order with respect to the second subtext column 2962, for example, the first subtext column 2961. The processor may transmit the first actuation signal, which has changed based on the first subtext column 2961, to the first information output portion 2911, to output tactile information regarding the first subtext column 2961.

That is, the processor may change the subtext columns when the first operation key 2921 and the fourth operation key 2924 are selected, allowing the full text to be confirmed through the text movement function. The processor may support the text movement in the first information output portion 2911 in units of the subtext columns divided based on the output range of the first information output portion 2911, but is not limited to this and may support text movement based on a set unit (e.g., a preset number of syllables, sentences, information output cells, etc.).

In an embodiment, the processor may control a text reading section to move to a previous reading section based on a preset unit when a second operation key 2922 is selected from among the plurality of operation keys for a touch holding time less than a preset threshold. Also, the processor may control a text reading section to move to the next reading section based on a preset unit when a third operation key 2923 is selected from among the plurality of operation keys for a touch holding time less than a preset threshold. Here, the preset unit may include at least one of a sentence, paragraph, page, bookmark, and chapter.

In addition, the processor may control a text reading operation to be activated or deactivated when a first operation key 2921 and a second operation key 2922 (combination key) are selected from among the plurality of operation keys for a touch holding time less than a preset threshold.

The processor may control a bookmark to be designated in or released from a text reading section of the text reading device when a third operation key 2923 and a fourth operation key 2924 (combination key) are selected from among the plurality of operation keys for a touch holding time less than a preset threshold.

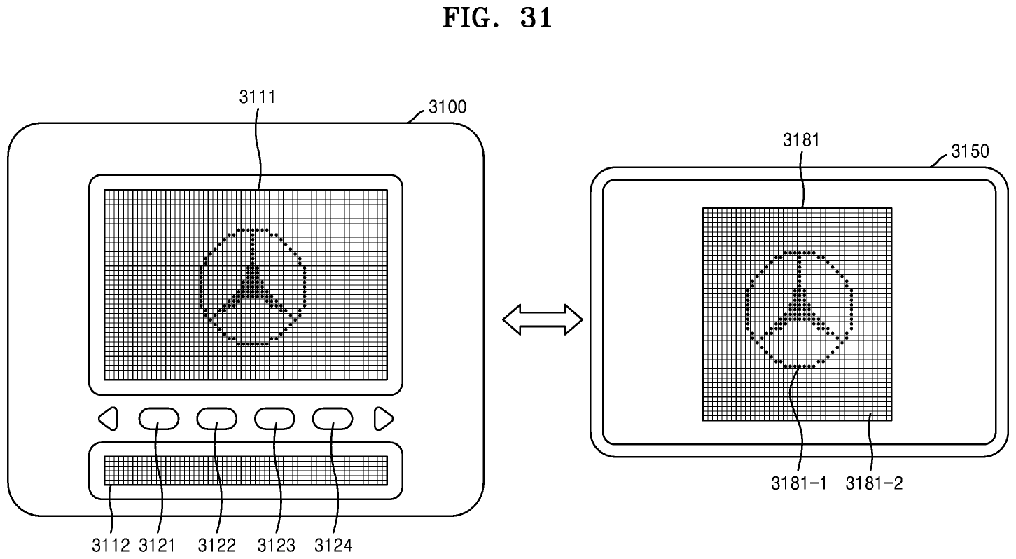

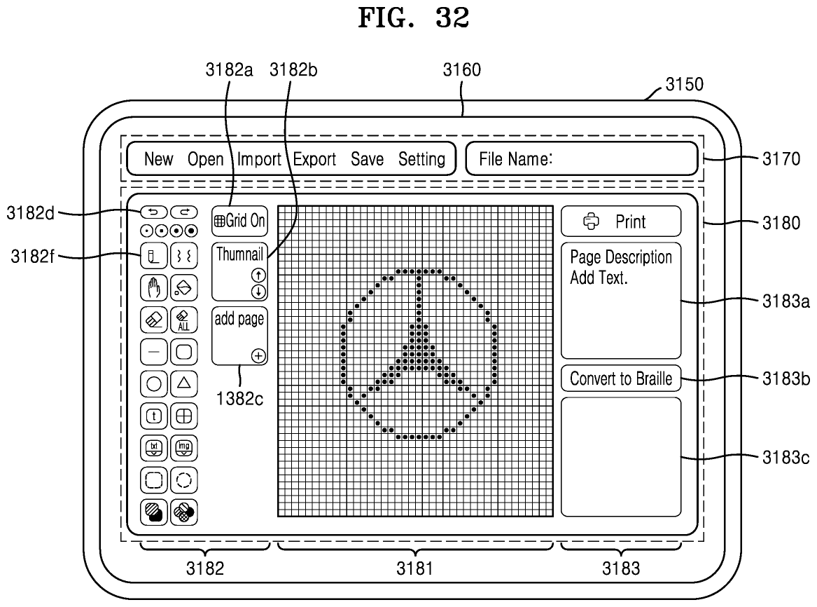

FIG. 31 is a diagram of another example of controlling an external device in an information output apparatus according to an embodiment. FIG. 32 is a diagram of an example of an interactive information processing apparatus, as an external device, connected to an information output apparatus, according to an embodiment.

Referring to FIG. 31, the processor of an information output apparatus 3100 may be connected to, as a compatible external device, an interactive information processing device 3150 including a user interface panel, and may receive compatibility information from the connected interactive information processing device 3150. Here, the compatibility information may be information that is output from the user interface panel or input into the user interface panel.

The interactive information processing device 3150 connected to the information output apparatus 3100 may include a user interface panel 3160 that provides an input interface to a user, as shown in FIG. 32.

The user interface panel 3160 may include a first user interface area 1370 and a second user interface area 3180.

The first user interface area 1370 may include a plurality of menus, and may manage (e.g., open, insert, save, etc.) a file associated with the second user interface area 3180 (or a file generated by the second user interface area 3180 or an externally received file), through an input to select a menu.

The second user interface area 3180 may have a plurality of areas, for example, first through third areas 3181 through 3183.

The first area 3181 may be an area divided into a plurality of grid cells, and may output compatibility information for communication with the information output apparatus 3100. The interactive information processing device 3150 may control information related to at least one of an image and a text, in response to a touch input to the first area 3181. Furthermore, the interactive information processing device 3150 may open a file on the first area 3181 to output information related to at least one of an image and a text included in the file.

The second area 3182 may include a plurality of menus, and compatibility information output to the first area 3181 may vary depending on the selection of a menu.

The third area 3183 may include a page description window 3183a, through which an input of a description text for compatibility information output in the first area 3181 may be received, and a braille output window 3183c on which results of converting the description text into braille letters are displayed.

The interactive information processing device 3150 may perform a function corresponding to a menu, in response to the selection of the menu provided on the second area 3182.

For example, the interactive information processing device 3150 may display a plurality of grid cells in the first area 3181 or stop displaying the plurality of grid cells in the first area 3181, in response to a touch applied to a grid cell display menu 3182a provided in the second area 3182.

In addition, the interactive information processing device 3150 may move (switch) files in a unit of page (thumbnail) according to the reception of a touch signal for a page move menu (page switch menu), or add a new page to pre-stored pages according to the reception of a touch signal for a page add menu 3182c. In response to the reception of a touch signal for an Undo/Redo menu 3182d, the interactive information processing device 3150 may undo a touch signal applied to the first area 3181 or cancel the undo.

The interactive information processing device 3150 may activate a pen upon receiving a touch signal for a pen menu 3182f, and control information input by a user to be displayed upon receiving a click and drag on the first area 3181.

Additionally, upon receiving a touch signal for the braille convert menu 3183b, the interactive information processing device 3150 may convert a description text input to the page description window 3183a into braille letters and output the result of the conversion into the braille letters to the braille output window 3183c (page description-braille area). When transmitting compatibility information to the information output apparatus 3100, the interactive information processing device 3150 may transmit the compatibility information, which is output in the first area 3181, by including the braille conversion result for the description text.

Referring back to FIG. 31, upon receiving compatibility information from the interactive information processing device 3150, the processor of the information output apparatus 3100 may output the compatibility information through at least one of the first information output portion 3111 and the second information output portion 3112. First, as the interactive information processing device 3150 is connected, the processor may one-to-one match coordinate information regarding a plurality of grid cells with coordinate information regarding information output cells within an information output portion (at least one of the first information output portion 3111 and the second information output portion 3112). In this regard, the coordinate information regarding the plurality of grid cells may be extracted from the compatibility information received from the interactive information processing device 3150, or may be received in advance when the information output apparatus 3100 and the interactive information processing device 3150 are connected, to be stored in the memory of the information output apparatus 3100. Additionally, the coordinate information regarding the information output cells within the information output portion may be stored in advance in the memory of the information output apparatus 3100.

Specifically, the processor may allocate some of the plurality of grid cells to the first information output portion 3111 and allocate the rest of the plurality of grid cells to the second information output portion 3112. The processor may one-to-one match coordinate information related to the allocated grid cells with coordinate information related to a first information output cell within the first information output portion 3111 and coordinate information related to a second information output cell within the second information output portion 3112. Here, one-to-one matching may refer to that the number of grid cells constituting the first area 3181 is the same as the number of information output cells constituting the information output portion (i.e., the first information output cells constituting the first information output portion 3111 and the second information output cells constituting the second information output portion 3112). That is, the coordinate information of the grid cells and the coordinate information of the information output cells may be the same.

However, the coordinate information of the grid cells and the coordinate information of the information output cells may not be necessarily the same, and the coordinate information of the grid cells and the coordinate information of the information output cells may be different. When the coordinate information of the grid cells and the coordinate information of the information output cells are different, the coordinate information of the grid cells and the coordinate information of the information output cells that matches the coordinate information of the grid cells may be tabulated and stored in the memory of the information output apparatus 3100.

The processor may generate a first actuation signal for first information output units within the first information output cell and a second actuation signal for second information output units within the second information output cell, based on the compatibility information received from the interactive information processing device 3150 through one-to-one matching. The processor may transmit the first actuation signal and the second actuation signal to the first information output portion 3111 and the second information output portion 3112, respectively, such that tactile information related to the compatibility information received from the interactive information processing device 3150 is output to the first and second information output portions 1311 and 1312. Accordingly, information output through the user interface panel 3160 of the interactive information processing device 3150 may be output to the first information output portion 3111 and the second information output portion 3112.

In an embodiment, the processor may allocate a plurality of grid cells to the first information output portion 3111 and the second information output portion 3112, but is not limited thereto, and may allocate a plurality of grid cells to the first information output portion 3111. The processor may one-to-one match coordinate information related to the allocated grid cells with coordinate information related to first information output cells, and the one-to-one matching may enable the processor to generate a first actuation signal for first information output units based on the compatibility information received from the interactive information processing device 3150. Here, one-to-one matching may refer to that the number of grid cells constituting the first area 3181 and the number of first information output cells included in the first information output portion 3111 are the same. The processor may transmit the first actuation signal to the first information output portion 3111 to output tactile information related to the compatibility information through the first information output portion 3111. For example, when an image of ‘Benz logo’ is received as compatibility information, the processor may allocate a plurality of grid cells to the first information output portion 3111, and generate a first actuation signal for first information output units within the first information output cell based on the image of ‘Benz logo’ through one-to-one matching between the coordinate information related to the allocated grid cells and the coordinate information related to the first information output cell. In this regard, the processor may classify the plurality of grid cells into grid cells (e.g., 3181-1 of FIG. 31) displaying meaningful information and grid cells (e.g., 3181-2 of FIG. 31) displaying meaningless information, based on the image of ‘Benz logo’ formed based on the plurality of grid cells. The processor may generate a first actuation signal so that information output units are actuated to protrude for the grid cells displaying the meaningful information and information output units are actuated to retract for the grid cells displaying the meaningless information. The processor may transmit the first actuation signal to the first information output portion 3111 to output tactile information related to the image of ‘Benz logo’ through the first information output portion 3111, thereby facilitating perception of the image received from the interactive information processing device 3150.

In an embodiment, the processor may control a previous page to be displayed, based on a current page displayed on the user interface panel 3160 of the interactive information processing device 3150, in response to the selection of a first operation key 3121 from among a plurality of operation keys for a touch holding time less than a preset threshold. Furthermore, the processor may control a next page to be displayed, based on a current page displayed on the user interface panel 3160 of the interactive information processing device 3150, in response to the selection of a fourth operation key 3124 from among the plurality of operation keys for a touch holding time less than a threshold.

In addition, the processor may control a pen tool to be activated in the interactive information processing device 3150, in response to the selection of a second operation key 3122 from among the plurality of operation keys for a touch holding time less than a preset threshold.

The processor may control the user interface panel 3160 of the interactive information processing device 3150 to be initialized, in response to the selection of a third operation key 3123 from among the plurality of operation keys for a touch holding time less than a preset threshold.

The processor may control a new page to be generated, in addition to a page displayed on the user interface panel 3160 of the interactive information processing device 3150, in response to the selection of the first operation key 3121 and the second operation key 3122 from among the plurality of operation keys for a touch holding time less than a preset threshold. Also, the processor may control a page displayed on the user interface panel 3160 of the interactive information processing device 3150 to be deleted, in response to the selection of a third operation key 3123 and a fourth operation key 3124 from among the plurality of operation keys for a touch holding time less than a preset threshold.

The processor may control a touch mode, which enables a touch-based input with respect to the user interface panel 3160 of the interactive information processing device 3150, to be activated or deactivated, in response to the selection of the second operation key 3122 and the third operation key 3123 (combination key) from among the plurality of operation keys for a touch holding time less than a preset threshold.

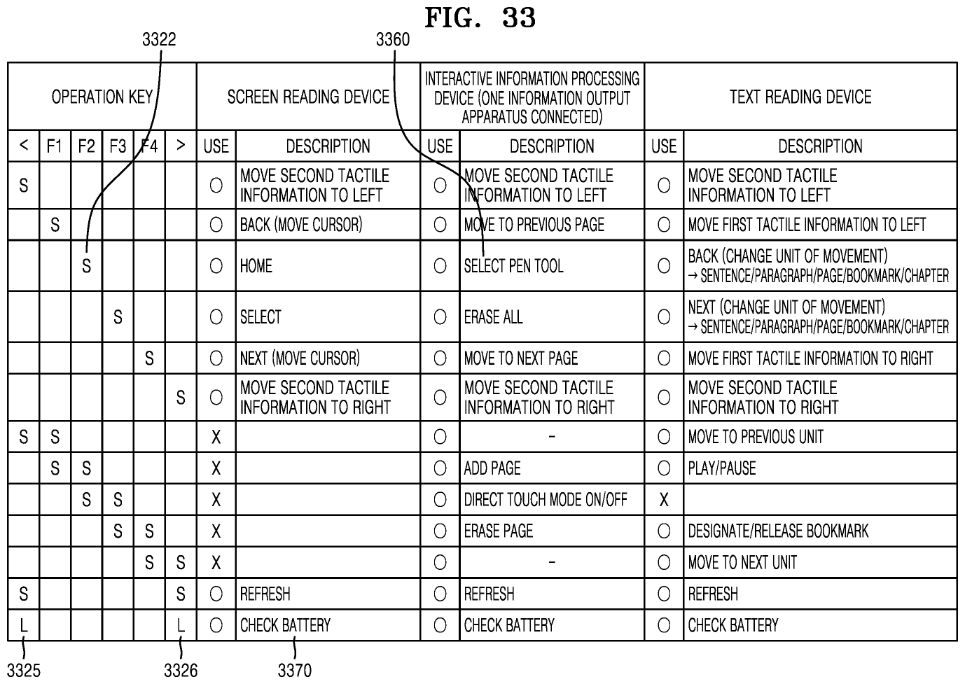

FIG. 33 is a diagram of an example of the performance of functions, in the form of table, according to selection of manipulation keys in an information output apparatus, according to an embodiment.

Referring to FIG. 33, an information output apparatus may perform functions corresponding to one or more operation keys, selected from among a plurality of operation keys, for each external device (e.g., a screen reading device, an interactive information processing device, or a text reading device). The functions performed to correspond to one or more operation keys selected from among the plurality of operation keys are not limited to those shown in the table and may vary in various ways.

A plurality of operation keys, for example, the operating unit (320 of FIG. 21) may include a left operation key <, a first operation key F1, a second operation key F2, a third operation key F3, a fourth operation key F4, and a right operation key >. In addition, S (Short) may denote that an operation key is selected for a touch holding time less than a preset threshold, and L (Long) may denote that an operation key is selected for a touch holding time longer than or equal to the preset threshold.

For example, when the second operation key F2 is selected from among a plurality of operation keys in a touch holding time less than a preset threshold (3322) in a state where the information output apparatus is connected to an interactive information processing device as a compatible external device, the information output apparatus may control a pen tool to be activated in the interactive information processing device (3360).

In addition, when the left operation key < and the right operation key > are selected (3325, 3326) from among the plurality of operation keys in a touch holding time longer than or equal to the preset threshold in a state where the information output apparatus is connected to a screen reading device as a compatible external device, the information output apparatus may check and output a remaining battery capacity thereof (3370).

In an embodiment, when it is determined that another output apparatus is connected to an interactive information processing device as a compatible external device in a state where the information output apparatus is connected to the interactive information processing device, the information output apparatus may restrict the performance of functions (e.g., movement to the previous page, selection of the pen tool, etc.) of some of the plurality of operation keys, thereby suppressing malfunctions of the external device that may occur because the external device is controlled in a plurality of information output apparatuses by incompatible functions.

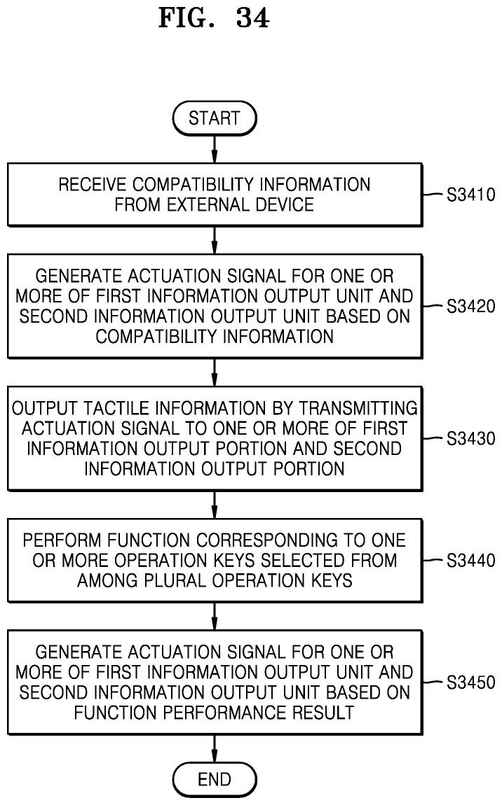

FIG. 34 is a flowchart of an information output method according to an embodiment. Hereinafter, redundant descriptions with the descriptions for FIGS. 19 to 33 will be omitted. An information output method may be performed by an information output apparatus according to an embodiment.

Referring to FIG. 34, the information output apparatus may be connected to a compatible external device and receive compatibility information from the connected external device in operation S3410.

The information output apparatus may generate an actuation signal for one or more of a first information output unit and a second information output unit based on the compatible information in operation S3420. That is, the information output apparatus may generate at least one of a first actuation signal for a first information output unit included in a first information output portion and a second actuation signal for a second information output unit included in a second information output portion.

When image and text are extracted from the compatibility information, the information output apparatus may generate the first actuation signal for actuating the first information output unit based on the image and the second actuation signal for actuating the second information output unit based on the text.

The information output apparatus may output tactile information by transmitting the actuation signal to one or more of the first information output portion and the second information output portion in operation S3430. Here, the first information output portion may output first tactile information by actuating one or more first information output units to protrude or retract. The second information output portion may be disposed at a different position from the first information output portion and output second tactile information by actuating one or more second information output units to protrude or retract.

The information output apparatus may receive an input selecting one or more operation keys from among a plurality of operation keys and perform a function corresponding to the selected one or more operation keys in operation S3440. The plurality of operation keys, for example, may include a left operation key, a first operation key, a second operation key, a third operation key, a fourth operation key, and a right operation key.

In an embodiment, the information output apparatus may perform a function corresponding to a single operation key, in response to the single operation key being selected, and perform functions corresponding to a plurality of operation keys (combination keys), in response to the plurality of operation keys being selected.

The information output apparatus may perform a different function not only depending on the type of an operation key selected but also depending on the touch holding time of an operation key.

The information output apparatus may generate an actuation signal for one or more of the first information output unit and the second information output unit based on the result of performing a function (e.g., compatibility information newly received from an external device), and transmit the actuation signal to one or more of the first information output portion and the second information output portion, to thusly update tactile information to be output in operation S3450.

An information output apparatus according to an embodiment of the present disclosure may control first and second information output portions to output tactile information by actuating one or more information output units to protrude or retract based on input information (e.g., compatibility information received from an external device), such that an image is displayed on the first information output portion and a text is displayed on the second information output portion, resulting in easily perceiving various types of information through tactile sensation.

In addition, an information output apparatus according to an embodiment of the present disclosure may perform a function corresponding to one or more operation keys selected according to an input for selection with respect to a plurality of operation keys, resulting in changing tactile information based on compatibility information with an external device to facilitate the control for the output of the tactile information or controlling the operation of the external device to effectively utilize the external device.

An embodiment of the present disclosure can also be embodied as a computer program executed on a computer using various elements. The computer program may be recorded in a computer readable recording medium. Examples of the computer readable recording medium may include magnetic media such as hard disks, floppy disks, and magnetic tapes; optical media such as CD-ROMs and DVDs; magneto-optical media such as floptical disks; and hardware devices such as read-only memory (ROM), random-access memory (RAM), and flash memory that are specially configured to store and execute program commands.

Meanwhile, the computer program may be specially designed and configured for the present disclosure or may have been known to and usable by those skilled in the field of computer software. Examples of the computer program may include machine codes created by a compiler and high-level language codes that can be executed in a computer using an interpreter.

The use of the terms “a” and “an” and “the” and similar referents in the context of describing embodiments (especially in the context of the following claims) are to be construed to cover both the singular and the plural. Furthermore, recitation of ranges of values herein is merely intended to serve as a shorthand method of referring individually to each separate value falling within the range, unless otherwise indicated herein, and each separate value is incorporated into the specification as if it were individually recited herein.

Also, the steps of all methods described herein can be performed in any suitable order unless otherwise indicated herein or otherwise clearly contradicted by context. The present disclosure is not limited to the described order of the steps. The use of any and all examples, or exemplary language (e.g., “such as”) provided herein, is intended merely to better illuminate the present disclosure and does not pose a limitation on the scope of present disclosure unless otherwise claimed. It will be apparent to one of ordinary skill in the art that numerous modifications, combinations, and adaptations can be made according to design conditions and factors without departing from the spirit and scope of the attached claims or their equivalents.

Therefore, the spirit of the present disclosure is not limited to the embodiments described above, and the scope of the appended claims and equivalents to the scope or equivalently changed scopes will be construed as being included in the scope of the spirit of the present disclosure.

What is claimed is:

1. An information output apparatus comprising:
a first information output portion configured to output first tactile information by actuating one or more first information output units to protrude or retract;
a second information output portion disposed at a different position from the first information output portion and configured to output second tactile information by actuating one or more second information output units to protrude or retract;
an operating unit including a plurality of operation keys; and
a processor configured to generate, in response to a compatible external device being connected, an actuation signal for one or more of the first information output unit and the second information output unit, based on compatibility information received from the external device, transmit the generated actuation signal to one or more of the first information output portion and the second information output portion, and perform a function corresponding to one or more operation keys selected from among the plurality of operation keys.

2. The information output apparatus of claim 1, wherein the processor is configured to
change one or more of the first tactile information output to the first information output portion and the second tactile information output to the second information output portion based on the compatibility information, according to the one or more operation keys selected from among the plurality of operation keys.

3. The information output apparatus of claim 1, wherein the processor is configured to
control an operation of the external device according to the one or more operation keys selected from among the plurality of operation keys.

4. The information output apparatus of claim 1, wherein the plurality of operation keys include a first operation key and a second operation key, and
the processor is configured to perform a first function corresponding to the first operation key, in response to selection of the first operation key, and perform a second function corresponding to a combination of the first operation key and the second operation key, in response to selection of the second operation key together with the first operation key.

5. The information output apparatus of claim 1, wherein the processor is configured to perform a different function depending on a touch holding time of the operation key.

6. The information output apparatus of claim 1, wherein the processor is configured to perform a function of the one or more operation keys differently depending on a type of the external device.

7. The information output apparatus of claim 1, wherein
the external device is an interactive information processing device including an area divided into a plurality of grid cells constituting a user interface panel, and
the processor is configured to allocate the plurality of grid cells to the first information output portion, one-to-one match coordinate information related to the grid cells with coordinate information related to first information output cells included in the first information output portion, and generate an actuation signal for the first information output unit based on the compatibility information through the one-to-one matching.

8. The information output apparatus of claim 1, wherein the processor is configured to generate a first actuation signal for actuating the first information output unit based on an image extracted from the compatibility information, and a second actuation signal for actuating the second information output unit based on a text extracted from the compatibility information.

9. The information output apparatus of claim 1, wherein the processor is configured to
divide the first information output portion into a first sub-information output portion and a second sub-information output portion as an image and a first text and a second text which describe the image are extracted from compatibility information,
generate a 1-1th actuation signal for actuating the first information output unit included in any one of the first sub-information output portion and the second sub-information output portion, on the basis of the image,
generate a 1-2th actuation signal for actuating the first information output unit included in another one of the first sub-information output portion and the second sub-information output portion, on the basis of the first text, and
generate a second actuation signal for actuating the second information output unit included in the second information output portion, on the basis of the second text.

10. The information output apparatus of claim 1, wherein the processor is configured to restrict some of the plurality of operation keys from being performed when information about a connection of another information output apparatus to the external device is received in a state where the information output apparatus is connected to the external device.

11. An information output method performed by an information output apparatus, the method comprising:
generating an actuation signal for one or more of a first information output unit and a second information output unit based on compatibility information received from a compatible external device, in response to the compatible external device being connected;
transmitting the actuation signal to one or more of a first information output portion and a second information output portion; and
receiving an input selecting one or more operation keys from among a plurality of operation keys to perform a function corresponding to the selected one or more operation keys,
wherein the first information output portion outputs first tactile information by actuating one or more first information output units to protrude or retract, and
the second information output portion is disposed at a different position from the first information output portion and outputs second tactile information by actuating one or more second information output units to protrude or retract.
